(19) United States
(12) Patent Application Publication
(10) Pub. No.: US 2015/0100993 A1
(43) Pub. Date: Apr. 9, 2015

(54) SEAMLESS PLAYBACK METHOD USING BOOKMARK, AND APPARATUS AND SYSTEM THEREFOR

(71) Applicant: LG ELECTRONICS, INC., Seoul (KR)

(72) Inventors: Minsoo Lee, Seoul (KR); Sijeong Ro, Seoul (KR); Kilsung Lee, Seoul (KR); Sungsoo Kim, Seoul (KR); Yujung Jung, Seoul (KR); Changhyun Oe, Seoul (KR); Sangwoon Park, Seoul (KR)

(73) Assignee: LG ELECTRONICS INC., Seoul (KR)

(21) Appl. No.: 14/385,043

(22) PCT Filed: Mar. 13, 2013
(86) PCT No.: PCT/KR2013/002018

§ 371 Date: Sep. 12, 2014

Related U.S. Application Data
(60) Provisional application No. 61/609,948, filed on Mar. 13, 2012.

(51) Int. Cl. H04N 21/433; H04N 5/783; H04N 5/765; H04N 9/82; H04N 21/488; H04N 21/654; H04N 21/6587; H04N 21/435; H04N 21/439; H04N 21/8547; H04N 21/472; H04N 21/2387

(52) U.S. Cl. CPC H04N 21/4333; H04N 21/47217; H04N 5/783; H04N 5/765; H04N 9/8205; H04N 21/47214; H04N 21/2387; H04N 21/47205; H04N 21/654; H04N 21/6587; H04N 21/435; H04N 21/4394; H04N 21/8547; H04N 21/4884
USPC 725/90

(57) ABSTRACT

A seamless playback method using a bookmark, and an apparatus and a system therefore are disclosed. The seamless playback method using the bookmark receives, from one of a prior device and a prior server, the bookmark comprising playback information on the prior device which had previously played back contents, enables the device to set the playback information for playing back the contents on the basis of the playback information of the prior device, and can play back, from a resumed playback time point, the contents and additional contents corresponding to the set playback information on the basis of the set playback information. Thus, the contents stopped during a playback process of the device can be continuously and automatically played back in the same playback setting as the device using another device.

### BACKGROUND OF THE INVENTION

1. Field of the Invention

The present invention relates to a method, apparatus, and system for seamless playback using a bookmark and, more particularly, to a seamless playback technology in which content that was played back by a device and stopped can be automatically played back seamlessly in the same manner as the playback setting of the device using another device.

2. Related Art

In general, digital content, such as multimedia content and audio content, is advantageous in that it can be freely distributed and obtained, but it may be easily exposed to illegal behaviors, such as unauthorized copy or leakage, because the digital content can be unlimitedly copied even without the loss of its data. Accordingly, in order to create a sound digital content use environment, a content protection technology capable of stably protecting digital content against illegal behaviors needs to be supported.

Digital Rights Management (DRM) is a comprehensive digital content protection system for preventing the illegal copy and use of digital content and allowing only a user having legitimate rights to use permitted digital content. Such DRM adopts various element technologies, such as the safe distribution and spread of content, control of the use rights of content according to a policy, and encryption and decryption.

However, conventional DRM is problematic in that the range that a user uses content is excessively limited because it has technology and policy closure in terms of its characteristic. For example, each of pieces of digital content provided by a plurality of service providers may be used by only a DRM device or software to which DRM adopted by each service provider has been applied. That is, digital content protected by specific DRM may be used only in a device that supports the corresponding DRM. Such a problem acts as a actor that deteriorates the flexibility of a digital content distribution system.

Accordingly, efforts are recently attempted to freely share and play back various types of media content within an authenticated network regardless of a service provider, the manufacturer of a device, or a product type. For example, Korean Patent. Application Publication No. 2009-0001973 describes technologies in which the domain of a plurality of devices operating in conjunction with each other over a network is configured and content is shared between the devices within the domain.

For a framework through which pieces of content of heterogeneous service providers can be seamlessly played back so that they are compatible between various devices, an operation model capable of defining the entities and resources of a system and generating and managing the defined system entities and resources needs to be able to be present. Furthermore, when content playback is subjected to handover between devices based on the defined system resources and the operation model, a user needs to be able to seamlessly watch content in the same environment.

### SUMMARY OF THE INVENTION

The present invention has been made to solve such problems, and an object of the present invention is to provide a method, apparatus, and system for seamless playback using a bookmark, wherein content that was played back by a device and stopped can be automatically played back seamlessly in the same manner as the playback setting of the device using another device.

In order to achieve such an object, in an aspect, the present invention provides a seamless playback method using a bookmark. The seamless playback method using a bookmark includes the steps of receiving a bookmark, including playback information of a previous device that previously played back content, from any one of the previous device and a server; setting playback information for playing back the content in the device based on the playback information of the previous device; and playing back the content and additional content corresponding to the set playback information from a resumption playback time point based on the set playback information.

The bookmark may include a content ID for identifying the content, information about a previous subtitle language indicative of a subtitle language set in the previous device, information about a previous subtitle type indicative of a subtitle type set in the previous device, previous audio track language information indicative of an audio track language set in the previous device, previous audio track type information indicative of a type of audio track set in the previous device, and the resumption playback time point indicative of a point of time at which the playback of the content is to be resumed in the device.

The step of setting the playback information may include at least any one of the steps of selecting information about a subtitle to be played back in association with the content based on previous subtitle information included in the bookmark and selecting information about an audio track to be played back in association with the content based on previous audio track information included in the bookmark.

The step of setting the playback information may include the steps of selecting information about additional content to be played back in association with the content identically with information about additional content set in the previous device based on the bookmark; displaying the selected information about additional content using a user interface; and setting the selected information about additional content in response to a user request input signal.

The seamless playback method may further include the steps of discovering the previous device by performing device discovery and requesting the bookmark, including the playback information of the previous device, from the previous device.

The step of receiving a bookmark, including playback information of a previous device that previously played back content, from any one of the previous device and a server may include a step of receiving a content bookmark list including at least one bookmark corresponding to at least one piece of content.

The seamless playback method may further include the steps of displaying a user interface based on the content bookmark list and extracting a bookmark, corresponding to the content, from the bookmark list when the content is selected from the content bookmark list. The user interface based on the bookmark list may display a list of a plurality of pieces of content including the at least one piece of content and may display information indicative that resumption playback of content including a corresponding bookmark is possible.

Meanwhile, in order to achieve the aforementioned object, in another aspect, the present invention provides a seamless playback apparatus using a bookmark. The seamless playback apparatus using a bookmark may include an interface for receiving a bookmark, including playback information of a previous device that previously played back content, from any one of the previous device and a server and a processor for setting playback information for playing back the content in the device based on the playback information of the previous device and for playing back the content and additional content corresponding to the set playback information from a resumption playback time point based on the set playback information.

The processor may perform at least any one of selecting information about a subtitle to be played back in association with the content based on previous subtitle information included in the bookmark and of selecting information about an audio track to be played back in association with the content based on previous audio track information included in the bookmark. The processor may select information about additional content to be played back in association with the content identically with information about additional content set in the previous device based on the bookmark, may display the selected information about additional content using a user interface, and may set the selected information about additional content in response to a user request input signal.

Meanwhile, in order to achieve the aforementioned object, in yet another aspect, the present invention provides a seamless playback system using a bookmark. The seamless playback system using a bookmark may include a first device for generating a bookmark so that content and additional content associated with the content are able to be seamlessly played back in another device when playback of the content is stopped and a second device for receiving the bookmark generated by the first device from any one of the first device and a server, setting playback information for playing back the content based on the bookmark, and seamlessly playing back the content and additional content corresponding to the set playback information based on the set playback information.

The second device may perform at least any one of selecting information about a subtitle to be played back in association with the content based on previous subtitle information included in the bookmark and of selecting information about an audio track to be played back in association with the content based on previous audio track information included in the bookmark.

The second device may select information about additional content to be played back in association with the content identically with information about additional content set in the previous device based on the bookmark, may display the selected information about additional content using a user interface, and may set the selected information about additional content in response to a user request input signal.

The second device may receive a content bookmark list comprising at least one bookmark corresponding to at least one piece of content, may display a user interface based on the content bookmark list, and may extract a bookmark corresponding to the content from the bookmark list when the content is selected from the content bookmark list.

As described above, in accordance with the present invention, content that was played back by a first client device can be automatically seamlessly played back identically with pieces of playback information set when the content was played back by the first client device using a second client device based on a bookmark, that is, playback resumption information. Accordingly, when content playback is subjected to handover between devices, the same subtitle or audio track as that in a previous device is automatically played back by a new device although a user does not separately select a subtitle or an audio track in the new device.

### BRIEF DESCRIPTION OF THE DRAWINGS

FIG. 1 is a block diagram illustrating the configuration of a system for providing such open content market service.

FIG. 2 is a block diagram illustrating the configuration of modules included in a client device.

FIG. 3 is a flowchart illustrating an exemplary procedure of seamlessly playing back content between devices.

FIG. 4 is an exemplary diagram for illustrating a seamless playback method using a bookmark in accordance with a preferred embodiment of the present invention.

FIG. 5 illustrates a schema illustrating the format of a bookmark.

FIG. 6 is a flowchart illustrating a seamless playback method using a bookmark in accordance with another preferred embodiment of the present invention and illustrates an embodiment in which seamless playback is performed based on the pushing of a bookmark from a first client device to a second client device.

FIG. 7 is a flowchart illustrating a seamless playback method using a bookmark in accordance with yet another preferred embodiment and illustrates an embodiment in which seamless playback is performed based on the pulling of a bookmark from a first client device to a second client device.

FIG. 8 is a flowchart illustrating a seamless playback method using a bookmark in accordance with yet another preferred embodiment and illustrates an example in which seamless playback is performed based on communication between content servers.

FIG. 9 is a flowchart illustrating a seamless playback method using a bookmark in accordance with yet another preferred embodiment and illustrates an example in which a content server manages the content bookmark list of a user.

FIG. 10 is an exemplary diagram illustrating the user interfaces of a second client device according to the seamless playback method using a bookmark illustrated in FIG. 9.

FIG. 11 is a flowchart illustrating a seamless playback method using a bookmark in accordance with yet another preferred embodiment and illustrates an example in which a first content server manages the content bookmark list of a user and a second content server takes part in the delivery of a bookmark.

FIG. 12 is a flowchart illustrating a seamless playback method using a bookmark in accordance with yet another preferred embodiment and illustrates an example in which seamless playback is performed based on communication between content servers.

FIG. 13 is a flowchart illustrating a seamless playback method using a bookmark in accordance with yet another preferred embodiment and illustrates an example in which seamless playback is performed based on communication between streaming providers.

FIG. 14 is a flowchart illustrating a seamless playback method using a bookmark in accordance with yet another preferred embodiment and illustrates an example in which seamless playback is performed based on communication between retailers.

FIG. 15 is a flowchart illustrating a seamless playback method using a bookmark in accordance with yet another preferred embodiment and illustrates an example in which a coordinator that manages open content market service manages the content bookmark list of a user.

FIG. 16 is a flowchart illustrating a seamless playback method using a bookmark in accordance with yet another preferred embodiment and illustrates an example in which a coordinator manages the content bookmark list of a user and a second streaming provider takes part in the delivery of a bookmark.

FIG. 17 is a flowchart illustrating a seamless playback method using a bookmark in accordance with yet another preferred embodiment and illustrates an example in which seamless playback is performed based on communication between a coordinator and a second streaming provider.

FIG. 18 is a flowchart illustrating a seamless playback method using a bookmark in accordance with yet another preferred embodiment and illustrates an embodiment of a flowchart of a device for performing resumption playback based on a bookmark.

### DESCRIPTION OF EXEMPLARY EMBODIMENTS

The present invention may be modified in various ways and may have several embodiments, and specific embodiments are to be illustrated in the drawings and described in detail. However, it is not intended to limit the present invention to a specific embodiment, and it should be understood that the embodiment includes all changes, equivalents, and substitutions that are included in the spirit and technical scope of the present invention

Terms, such as the first and the second, may be used to describe a variety of elements, but the elements should not be limited by the terms. The terms are used to only distinguish one element from the other element. For example, a first element may be named a second element, and likewise a second element may be named a first element without departing from the scope of the present invention. A term ‘and/or’ includes a combination of a plurality of related and described items or any one of a plurality of related and described items.

When it is said that one element is described as being ‘connected’ to or ‘coupled’ with the other element, the one element may be directly connected to or coupled with the other element, but it should be understood that a third element may be interposed between the two elements. In contrast, when it is said that one element is described as being ‘directly connected’ to or ‘directly coupled’ with the other element, it should be understood that a third element is not present between the two elements.

Terms used in this application are used to describe only specific embodiments and are not intended to limit the present invention. An expression of the singular number should be understood to include plural expressions, unless clearly expressed otherwise in the context. Terms, such as ‘include’ or ‘have’, should be understood to indicate the existence of a described characteristic, number, step, operation, element, part, or a combination of them and understood to not exclude the existence of one or more other characteristics, numbers, steps, operations, elements, parts, or a combination of them or a possibility addition of them.

All terms used herein, including technical or scientific terms, have the same meanings as those typically understood by those skilled in the art unless otherwise defined. Terms, such as ones defined in common dictionaries, should be construed as having the same meanings as those in the context of related technology and should not be construed as having ideal or excessively formal meanings unless clearly defined in this application.

Hereinafter, preferred embodiments of the present invention are described in more detail with reference to the accompanying drawings. In describing the present invention, in order to help general understanding, the same reference numerals are used to denote the same elements throughout the drawings and a redundant description of the same elements is omitted.

First, the present invention discloses an open content market service which supports cross service and device compatibility service.

The cross service may mean a service capable of being compatible with a service between a plurality of content service providers or between a plurality of retail service provider. For example, a user may be provided with service from a plurality of content managers or a plurality of retail managers, linked to the open content market service, using the account of the open content market service as if the user is provided with content providing service from a single content manager or retail manager. That is, the user may purchase pieces of content from a plurality of content managers and use the purchased content if the account of the open content market service has only to be authenticated without a need to obtain authentication from each of the plurality of content managers and to purchase the content in order to purchase the content from each of the content managers.

Furthermore, the device compatibility service may mean a service through which purchased content may be shared and used between devices within a user domain. For example, a user may watch content, purchased using a smart phone, through the smart phone or may watch the purchased content through a PC or a TV set. Furthermore, a user may send purchased content from a smart phone to a PC or TV and may be provided with streaming service, provided through a smart phone, through a PC or TV.

Content distributed by the open content market service may include all types of digital content, for example, movies, broadcasting programs, multimedia content, such as Video On Demand (VoD) content, voice content, and software that may be distributed in a digital network environment.

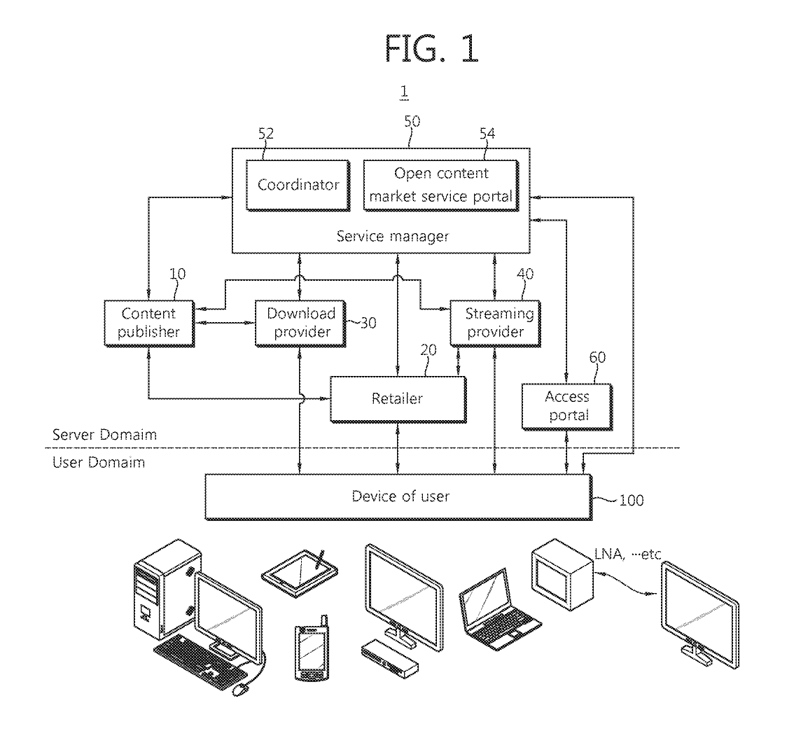

FIG. 1 is a block diagram illustrating the configuration of a system for providing such open content market service.

As illustrated in FIG. 1, the open content market service system 1 may be divided into a server domain and a user domain.

The server domain may operate services and policies for open content market service and provide content to the user domain based on the services and policies. That is, the server domain may mean a domain which includes servers for providing open content market service. Such a server domain may perform the providing of content to the user domain and the operation of service for the user domain, such as the production, selling, distribution, policy operation, and rights limit of content.

The server domain may include a content publisher 10, a retailer 20, a download provider 30, a streaming provider 40, a service manager 50, an access portal 60, etc. The content publisher 10, the retailer 20, the download provider 30, the streaming provider 40, the access portal 60, etc. include respective communication interfaces for the open content market service and may communicate with each other or communicate with the service manager 50 based on the communication interfaces.

The content publisher 10 may be the server of, for example, a film company, a broadcasting company, a record company, or the like. The content publisher 10 may distribute content, owned by the content publisher 10, to the user domain in cooperation with the retailer 20, the service manager 50, etc.

Such a content publisher 10 may perform content and metadata creation and identification, content packaging and encryption, and content and content encryption key delivery, for example. Furthermore, the content publisher 10 may send content encryption keys and metadata to a download provider, may send metadata to the retailer 20, and may send content and metadata to the streaming provider 40.

The retailer 20 may mean a consumer-facing storefront which sells content to consumers. For example, the retailer 20 may be a selling server that accesses the device 100 of the user domain and sells content to a user. Such a retailer 20 may have a function of managing a retail account. For example, the retailer 20 may include a retailer locker for managing a retailer account. A user may access the retailer 20 through the device 100 within the user domain, may check or search for a content list, and may purchase desired content. Meanwhile, the retailer 20 may include an open content market locker for managing the open content market service account. The open content market locker of the retailer 20 may operate in conjunction with the service manager 50.

The download provider 30 may be a download server for download content to the device 100 of the user domain. The download provider 30 may perform, for example, content management and delivery, native DRM license management, and so on. The download provider 20 may also be called a Digital Service Provider (DSP). The download provider 20 may be a content server for providing content to a client device using a download method.

The streaming provider 40 may mean a streaming server for streaming content to the device 100 of the user domain. The streaming provider 40 may perform, for example, content management, streaming service, etc. For example, the streaming provider 40 may stream content, linked to the rights of a user account, to the device 100. The streaming provider 40 may also be called a Locker Access Service Provider (LASP). The streaming provider 40 may be a content server for providing content to a client device using a streaming method.

The service manager 50 may mean a service server that operates the open content market service. For example, the service manager 50 may operate and manage roles for providing cross-service and device compatibility service, such as an account for the open content market service, a device domain, and a right locker.

The service manager 50 may store and manage pieces of information for the operation of the open content market service, such as a service policy, right information, domain information, and authentication information. Such a service manager may include a coordinator 52 and the open content market service portal 54.

The coordinator 52 may perform major functions related to the operation of the open content market service. For example, the coordinator 52 may perform content ID and metadata registries, user and account management, DRM domain managers, device management, rights management, and user and node authentication and authorization, etc.

The open content market service portal 54 may operate a portal for the open content market service. For example, the open content market service portal 54 may operate a client device portal based on REST (Resource-Oriented Application Programming Interface) and a web portal based on a Hypertext Markup Language (HTML) and may perform user authentication and authorization, and so on.

The access portal 60 may perform a function for linking the device 100 of the user domain to the entities of the server domain so that the device 100 can be provided with the open content market service. For example, the access portal 60 may mean a device proxy server for the open content market service. Such an access portal may provide another passage through which the device 100 can be provided with the open content market service. The access portal 60 may operate based on a web, for example and may include a user interface, a device API, etc. for a device accessed thereto.

Furthermore, the access portal 60 may enable a device not equipped with a function as a client for the open content market service, for example, a legacy device to be provided with the open content market service. For example, a device on which software that supports the open content market service is not mounted or a device not compatible with software that supports the open content market service may operate in conjunction with a service manager, etc. through the access portal 60. Such an access portal 60 may be functionally included in the server domain, but may be physically included in anywhere of the server domain or the user domain.

Meanwhile, the user domain may include the device 100 of a user that is provided with the open content market service. The device 100 may be a fixed type terminal, such as a PC or a set-top box, or may be a portable terminal, such as a smart phone, a Personal Digital Assistant (PDA), or a laptop computer. The device 100 may be equipped with modules for being provided with the open content market service. Such a device 100 may be called a client device.

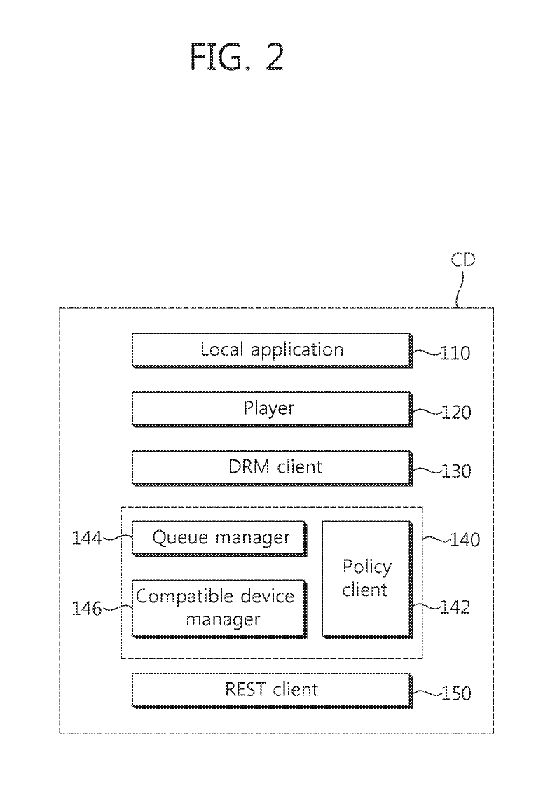

FIG. 2 is a block diagram illustrating the configuration of modules included in a Client Device (CD).

As illustrated in FIG. 2, the CD may include a local application 110, a player 120, a DRM client 130, a Queue/Policy Engine (QPE) 140, and a REST client 150, and so on.

The local application 110 may mean an application for the open content market service. For example, the local application 110 may be a user agent that provides a user interface, a service menu, service selection, etc. that enables a user to be provided with the open content market service.

The player 120 is for playing back content provided through the open content market service and may be, for example, a media player for playing back download content or streaming content. The DRM client 130 may perform processing related to the DRM of the CD. The REST client 150 may perform a function for a link to the device portal of the service manager 50 upon service.

The QPE 140 may perform a function for controlling device compatibility with another device so that the CD is compatible with another device, for example, a DLNA device within the user domain, managing the generation, transmission, and reception of a queue request, and controlling the CD according to a policy while communicating with the server side.

The QPE 140 may communicate with the server side and other devices of the user domain through a specific interface protocol. The QPE 120 may maintain a queue on behalf of each local application 110 and each content server, for example, the streaming provider 40 or the download provider 30, may interface with the storage of the CD, and may be responsible for synchronization between a queue request and a policy. Accordingly, the QPE may also be called a service client for content sharing service.

The QPE 140 may include a policy client 142, a queue manager 144, a compatible device manager 146, and so on.

The policy client 142 may control content sharing service or compatibility service based on a service policy. The policy client 142 may operate in conjunction with the coordinator 52, etc. which operates service policies in the entities of the server domain, for example, the service manager 50. The policy client 142 is a sub-system of the QPE 140 and manages policy objects. The policy client 142 may control the QPE 140 according to policies from the coordinator 52 that may be called a content policy server. For example, the policy client 142 may retrieve policies from the coordinator 52 and may adjust a queue request behavior.

The queue manager 144 may perform a function for operating queues for storing information related to the handover scheduling, playback scheduling, downloading scheduling, and streaming scheduling of content. That is, the queue manager 144 may manage the scheduling of the handover, playback, downloading, streaming, etc. of content. The queue manager 144 may include a stream queue manager, a download manager, and so on. The queue manager 144 may request the playback scheduling or downloading scheduling of content from another device linked to the CD or may schedule the content playback or downloading of the device 100 based on the playback scheduling or downloading scheduling of content received from another device.

For example, the queue manager 144 may send a queue request to another device and receive a response to the queue request from another device or may receive a queue request from another device and send a response to the queue request to another device. The queue manager 144 may send, to another device, a queue request that requests specific content to be downloaded or streamed from a content server and may receive a response to the queue request. The queue manager 144 may send, to another device, a queue request that requests content downloaded from a content server to be transmitted to the CD.

Such another device may be another client device included in the user domain and may be an intermediate device included in the user domain. In this case, the intermediate device may be a dual role client/server device on a network that may be used to stage assets destined for the CD. The intermediate device may temporarily hold an asset until the asset is delivered to the CD. In general, the intermediate device does not directly consume content, but may directly consume content.

The compatible device manager 146 may manage other device compatible with the CD, for example, other client devices or intermediate devices. For example, the compatible device manager 146 may perform a function for discovering a device to be linked to the CD, managing the state of a linked device, and sending or receiving messages for a linked device.

The configuration of the open content market service system 1 for realizing the open content market service that provides cross service compatible between heterogeneous content services and that provides compatible service between devices has been described above. In accordance with such an open content market service system 1, a user can be provided with free and flexible content services without being limited to the type of an individual content service provider or a device.

Various embodiments in which a user may seamlessly play back content while maintaining the content playback environment of a previous device although a device through which the user watches content is changed based on at least some elements of the open content market service system 1 are described below.

First, in order for a user to watch content, a first client device and a second client device may be provided. The first client device and the second client device may operate in conjunction with each other over a home network. The home network links devices and services that are distributed at several locations, such as information appliances, wireless communication devices, and devices related to Personal Computers (PCs), based on various standards, such as Digital Living Network Alliance (DLNA) and Universal Plug and Play (UPnP), through wired or wireless communication.

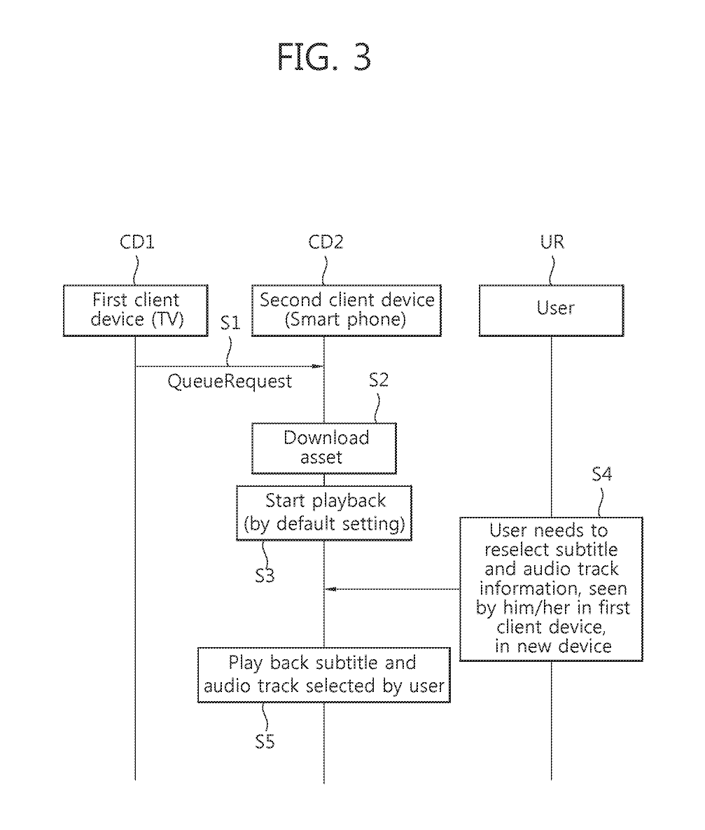

FIG. 3 is a flowchart illustrating an exemplary procedure of seamlessly playing back content between devices.

As illustrated in FIG. 3, a user UR watches content using a first client device CD1. For example, the first client device CD1 may be assumed to be TV included in the living room of the user UR.

Playback information for playing back the content has been set in the first client device CD1 in response to the selection of the user UR. For example, the playback information may include information for setting a subtitle and an audio track that are played back along with the content. Accordingly, when the content is played back, a subtitle, an audio track language, etc. may be synchronized with the content and played back in accordance with the playback information based on the selection of the user UR.

The user UR may stop the playback of the content by the first client device CD1 in order to go out or move to another room while watching the content through the first client device CD1.

After stopping the playback of the content by the first client device CD1, the user UR wants to continue to watch the stopped content that had been watched using the second client device CD2. The second client device CD2 may be assumed to be a smart phone of the user UR. Such service is possible through seamless playback that supports the seamless playback of content between devices.

First, when the playback of the content by the first client device CD1 is stopped in response to a seamless playback request from the user UR, the first client device CD1 may send a queue request that requests seamless playback to the second client device CD2 (step: S1). The queue request may include information about the ID of content and a point of time at which the playback of the content will begin again.

In response to the queue request, the second client device CD2 may download an asset corresponding to information about the ID of the content (step: S2) and may start the playback of the content from the point of time at which the playback of the content begins again (step: S3).

In this case, the user UR may be provided with the same subtitle and audio track as those provided by the previous first client device CD1 when the user UR watched the content from the second client device CD2.

To this end, the user UR needs to identically select the items of the playback information, for example, information about a subtitle and information about an audio track in the second client device CD2 so that the same playback information as that of a previous playback device, that is, the first client device CD1, is set through a user interface provided by the second client device CD2.

Accordingly, the second client device CD2 sets playback information based on the selection of the user UR and plays back the same subtitle and audio track as those of the first client device CD1 along with the content based on the playback information set when playing back the content.

In the case of the seamless playback illustrated in FIG. 3, when the playback of the content is subjected to handover from the first client device CD1 to the second client device CD2, the user UR needs to select the items of playback information so that the same playback information as that in the first client device CD1 is set in the second client device CD2 in order to use the same subtitle or audio track as that when the content was played back by the first client device CD1 in the second client device CD2.

Hereinafter, various embodiments in which although a user UR does not select the playback information of content using a second client device CD2 one by one when the playback of the content is subjected to handover from a first client device CD1 to the second client device CD2, the same playback information as that of the first client device CD1 is automatically set in the second client device CD2 and pieces of additional content linked to the content as well as the content are automatically seamlessly played back, thereby being capable of maximizing the convenience of the user UR, are described.

Each of the first client device CD1 and the second client device CD2 described in the following embodiments may be a network computer device of a hardware level, including a processor for computing, memory for storing data, an interface for communicating with a counterpart device, a display unit for displaying information, and an input unit for inputting information. In the operation of the first client device CD1 or the second client device CD2, calculation, control, etc. may be performed by processes, the storage of data may be performed by the memory, the transmission and reception of data may be performed through the interface, and the display and input of information may be performed by the display unit and the input unit, respectively.

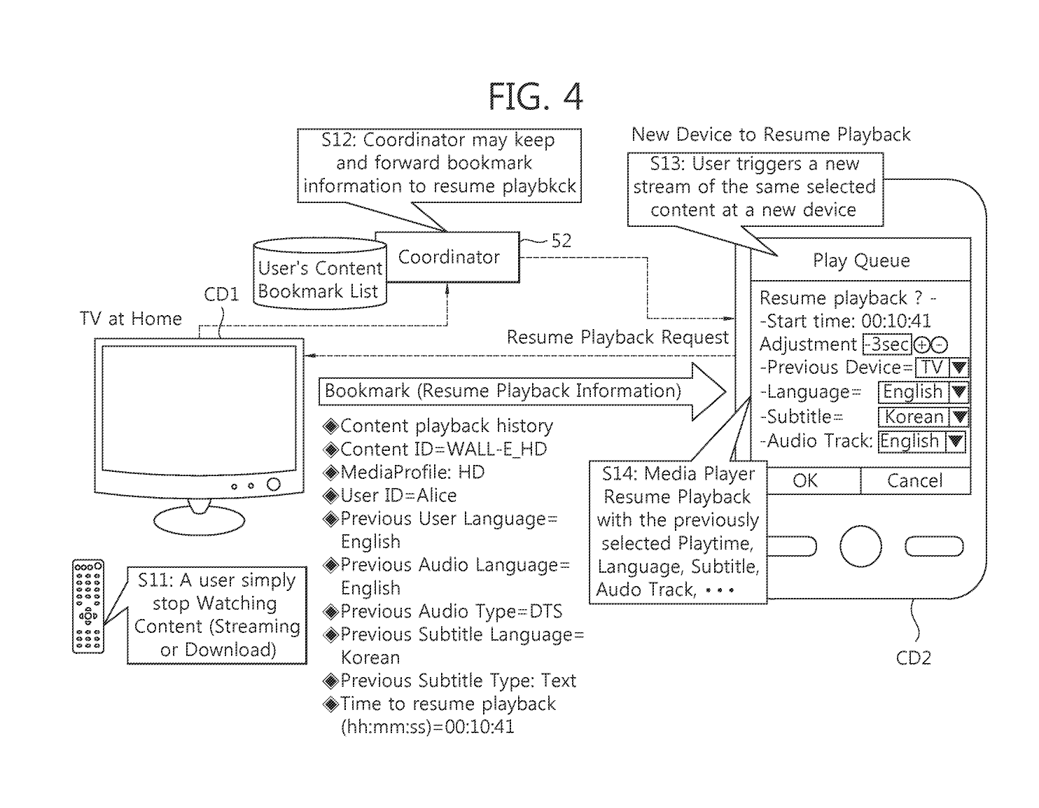

FIG. 4 is an exemplary diagram for illustrating a seamless playback method using a bookmark in accordance with a preferred embodiment of the present invention.

As illustrated in FIG. 4, a user UR watches content using a first client device CD1. That is, the first client device CD1 is playing back the content. For example, the first client device CD1 may be assumed to be TV included in the living room of the user UR.

The playback information of the content has been set in the first client device CD1 in response to the selection of the user UR. The playback information may include, for example, information for setting a subtitle and an audio track that are played back along with the content. Accordingly, when the content is played back, additional content may be played back along with the content based on the set playback information.

The user UR may stop watching the content through the first client device CD1 when the playback of the content by the first client device CD1 is stopped in order to go out or move to another room while watching the content through the first client device CD1 (step: S11).

After the playback of the content by the first client device CD1 is stopped, the user UR wants to continue to watch the watched content using a second client device CD2. The second client device CD2 may be assumed to be a smart phone of the user UR. In such a case, the user UR may request seamless playback using a seamless playback request window displayed on the first client device CD1.

In response to such a request, the first client device CD1 may generate a bookmark for seamless resumption playback through another device. The bookmark may mean resumption playback information that enables the content whose playback was stopped in the first client device CD1 to be seamlessly played back in another client device, for example, the second client device CD2. The bookmark may be implemented in a specific format.

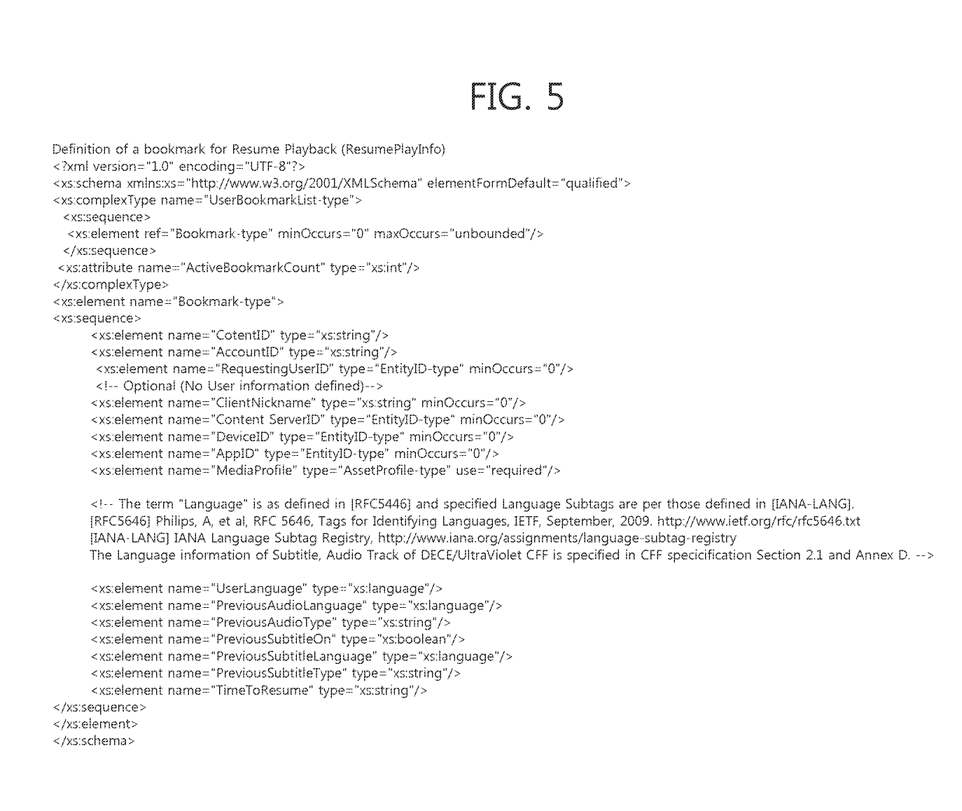

FIG. 5 illustrates a schema illustrating the format of a bookmark.

As illustrated in FIG. 5, the bookmark may include pieces of information indicative of the playback of a content history. For example, the bookmark may include a content ID “ContentID” for identifying content, information about a media profile “MediaProfile” indicative of the media profile of the content, a user ID “RequestinguserID” for identifying a user UR who has requested content playback, information about a previous user language “userLanguage” indicative of a user language set by default in a previous device, information about a previous audio language” PreviousAudioLanguage” indicative of the language of an audio track set in the previous device, information about a previous audio type “PreviousAudioType” indicative of the type of an audio track set in the previous device, previous subtitle-on information “PreviousSubtitleOn” indicative of whether or not a subtitle has been on in the previous device, information about a previous subtitle language “PreviousSubtitleLanguage” indicative of the language of a subtitle set in the previous device, information about a previous subtitle type “PreviousSubtitleType” indicative of the type of subtitle set in the previous device, information about a time point “TimeToResume” for resumption indicative of a point of time at which the playback of the content will begin again, and so on.

The bookmark may further include an asset ID to identify a physical asset corresponding to the content or may include an asset ID instead of the content ID. That is, the bookmark may designate only a content ID to be downloaded or may directly designate the asset ID of a physical asset to be actually downloaded that corresponds to the content.

The media profile information may include information about the definition of the content. For example, the profile may be information indicative of at least any one of High Definition (HD), Standard Definition (SD), Mobile Definition (MD), etc. That is, the media profile may be information indicative of whether the content is HD level content, SD level content, MD level content or the like.

Furthermore, the bookmark may further include content type information “ContentType” indicative of the type of content, an account ID “AccountID” for identifying the account of the user UR, a client nickname “clientNickName” indicative of a client nickname, a content server ID “ContentServerID” for identifying a content server, a device ID “deviceID” for identifying the previous device, an application ID “AppID” for identifying an application, and so on.

Meanwhile, in the example illustrated in FIG. 4, in accordance with a bookmark generated by the first client device CD1, “WALL-E_HD” has been set as a content ID, “HD” has been set as a media profile, “Alice” has been set as a user ID, “English” has been set as information about a previous user language, “English” has been set as information about a previous audio language, “DTS” has been set as information about a previous audio type, “Korean” has been set as information about a previous subtitle language, “Text” has been set as information about a previous subtitle type, and “00:10:41” has been set as information about a resumption playback time point.

That is, such a bookmark may be indicative that when a user UR having a user ID, that is, Alice, logins, the second client device CD2 needs to play back “WALL-E_HD”, that is, HD level media, from 10′41″ (i.e., “10 minutes, 41 second”), to play back the English audio track of a DTS type and the Korean subtitle of a text type along with the content, and to set English as a language used by default.

The bookmark generated by the first client device CD1 may be transmitted to the second client device CD2 through various roots according to an embodiment environment. For example, the bookmark may be directly transmitted from the first client device CD1 to the second client device CD2.

Alternatively, for example, the bookmark may be transmitted from the first client device CD1 to a specific server of the server domain, for example, the coordinator 52 and may be then delivered from the coordinator 52 to the second client device CD2 or delivered from the coordinator 52 to the second client device CD2 via at least one another server or device. The coordinator may manage the bookmark received from the first client device CD1. Furthermore, at least one bookmark corresponding to the content may be managed based on the content bookmark list of the user UR, etc. and the content bookmark list of the user UR may be delivered to the second client device CD2 directly or via at least one another server or device (step: S12).

Furthermore, the bookmark may be transmitted from the first client device CD1 to a content server or a retailer, such as a streaming provider or a download provider. In such a case, the content server or the retailer may manage the received bookmark. Furthermore, the content server or the retailer may manage the content bookmark list of the user UR. In such a case, the bookmark or the content bookmark list of the user UR may be transmitted from the content server or the retailer to the second client device CD2 directly or via at least one server or device.

When the bookmark, that is, the resumption playback information, is delivered to the second client device CD2, the second client device CD2 may set pieces of information for seamless playback based on the received bookmark. For example, the second client device CD2 may play back “WALL-END”, that is, HD level media, from 10′41″, may play back the English audio track of a DTS type and the Korean subtitle of a text type along with the content, and may set English as a language used in a user interface, etc.

As described above, the resumption playback information automatically set may be displayed through the user interface. For example, the second client device CD2 may automatically select pieces of information, set in respective selection items based on the resumption playback information, in the user interface for selecting the playback information of the content and may display the selected pieces of information. Accordingly, the user UR may trigger the stream of the content, automatically selected in the same manner as in the first client device CD1, in the second client device CD2 that is a new device (step: S13).

In response thereto, the media player of the second client device CD2 may seamlessly play back the content based on the information set based on the bookmark (step: S14). For example, the second client device CD2 may play back “WALL-E_HD”, that is, HD level media, from 10′41″ using the media player. In this case, the English audio track of a DTS type and the Korean subtitle of a text type are played back along with the content.

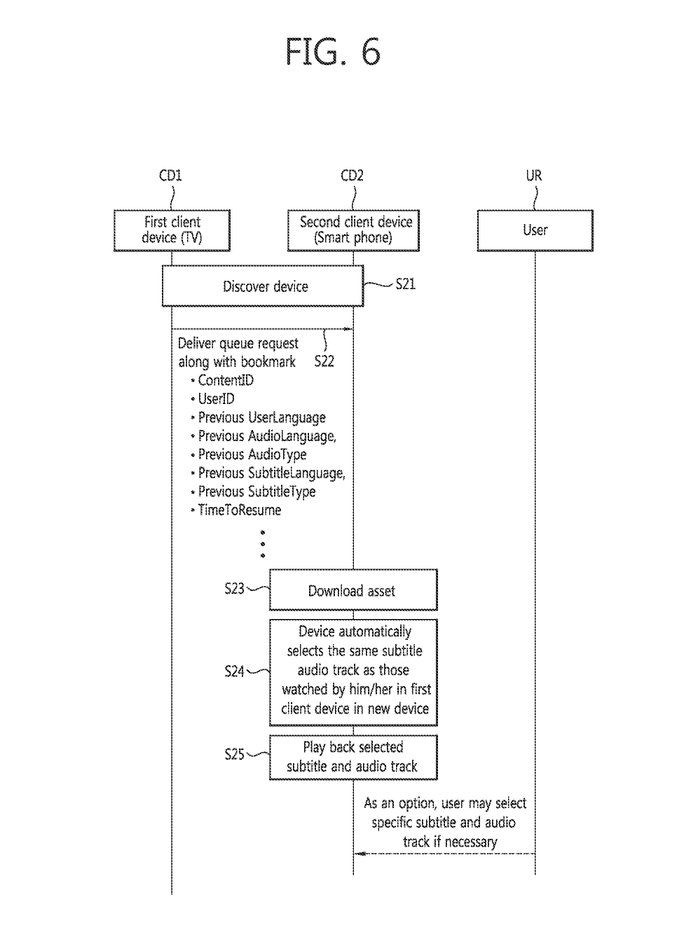

FIG. 6 is a flowchart illustrating a seamless playback method using a bookmark in accordance with another preferred embodiment of the present invention and illustrates an embodiment in which seamless playback is performed based on the pushing of a bookmark from a first client device CD1 to a second client device CD2.

As illustrated in FIG. 6, a user UR watches content using the first client device CD1. That is, the first client device CD1 is playing back the content. For example, the first client device CD1 may be assumed to be TV include in the living room of the user UR. Playback information of the content has been set in the first client device CD1 in response to the selection of the user UR. The playback information may include, for example, information for setting a subtitle or an audio track that is played back along with the content. Accordingly, when the content is played back, additional content may be played back along with the content based on the set playback information.

When the playback of the content by the first client device CD1 is stopped and seamless playback is requested in response to a request from the user UR, the first client device CD1 may perform device discovery in order to search for another device that will continue to play back the stopped content (step: S21).

The device discovery may be performed based on that the first client device CD1 broadcasts a discovery message to other devices connected to a network and the devices that have received the discovery message send response messages to the first client device CD1. Meanwhile, for rapid device discovery, the first client device CD1 may manage a recently connected device list including information about a recently accessed device and may update the recently connected device list whenever access is generated. In such a case, the first client device CD1 may send the discovery message to devices, included in the recently connected device list, using a unicast method and may receive response messages from the devices that have received the discovery message.

The first client device CD1 may display a list including at least one device discovered through the device discovery and may request the user UR to select a device that will perform seamless playback from among the discovered devices. In this case, assuming that the user UR has selected the second client device CD2, that is, his or her own smart phone, the first client device CD1 may set the second client device CD2 as a target device.

Thereafter, the first client device CD1 may generate a bookmark for content resumption playback in the second client device CD2 and send the bookmark to the second client device CD2 (step: S22). That is, the first client device CD1 pushes the bookmark to the second client device CD2.

The bookmark may include, for example, a content ID, a user ID, information about a previous user language, information about a previous audio language, information about a previous audio type, information about a previous subtitle language, information about a previous subtitle type, information about a resumption playback time point, and an asset ID.

The second client device CD2 that has received the bookmark may download the asset of the content from a content server, for example, a download server or a streaming server based on the received bookmark (step: S23). In this case, the second client device CD2 may preferentially download content after the resumption playback time point or may download only content after the resumption playback time point based on the resumption playback time point information of the bookmark. Alternatively, the second client device CD2 may preferentially decode the content after the resumption playback time point or may decode only the content after the resumption playback time point based on the resumption playback time point information of the bookmark.

Next, the second client device CD2 may automatically select pieces of playback information for the playback of the content, for example, subtitle-related information (e.g., information about a subtitle language and information about a subtitle type) or audio-related information (e.g., information about an audio language and audio type information) based on the received bookmark, that is, the resumption playback information and may set the selected pieces of playback information (step: S24).

For example, the second client device CD2 may automatically select information about a user language, information about a subtitle language, information about a subtitle type, information about a previous audio language, information about a previous audio type, etc. for playing back the content in the second client device CD2 based on the previous user language information, the previous subtitle language information, the previous subtitle type information, the previous audio language information, and the previous audio type information that are included in the bookmark and may set the selected information.

The second client device CD2 may play back the downloaded content from the resumption playback time point based on the set information (step: S25). For example, the second client device CD2 may play back the downloaded content from the resumption playback time point, but may temporally synchronize the subtitle or audio track, corresponding to the automatically selected information, with the downloaded content based on the resumption playback information and then play back the downloaded content.

If the user UR wants to set the subtitle or the audio track again, the second client device CD2 may display a user interface in which the resumption playback information may be set again, and the user UR may select desired subtitle information and desired audio track information.

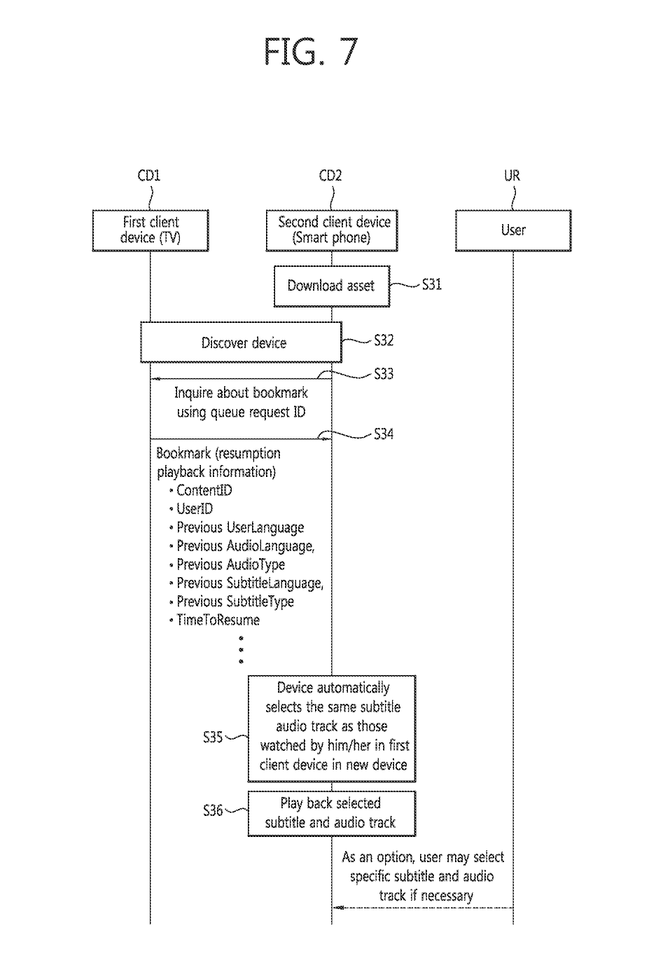

FIG. 7 is a flowchart illustrating a seamless playback method using a bookmark in accordance with yet another preferred embodiment and illustrates an embodiment in which seamless playback is performed based on the pulling of a bookmark from a first client device CD1 to a second client device CD2.

As illustrated in FIG. 7, the second client device CD2 may download the asset of content from a content server (step: S31). The content may be content that has been played back by the first client device CD1 and temporarily stopped. A user UR may wish to watch the content from a point of time at which the playback of the content has been terminated in the first client device CD1 and may request seamless playback through a user interface displayed on the second client device CD2.

In response to such a request, the second client device CD2 may perform device discovery in order to search for a device that previously played back the content (step: S32). The second client device CD2 discovers the first client device CD1 through the device discovery.

When the first client device CD1 is discovered, the second client device CD2 may send a request that requests a bookmark to the first client device CD1 (step: S33). That is, the second client device CD2 pulls the bookmark from the first client device CD1. The request may include a request ID. That is, the second client device may generate the request ID for the bookmark request and request the bookmark. Furthermore, the request may include a content ID, an asset ID, etc. That is, the second client device may request the bookmark using the ID information of the content or the asset.

In response to the request, the first client device CD1 may generate the bookmark for content resumption playback in the second client device CD2 based on playback information on which the content was previously played back and may send the generated bookmark to the second client device CD2 (step: S34). The bookmark may include, for example, a content ID, a user ID, information about a previous user language, information about a previous audio language, information about a previous audio type, information about a previous subtitle language, information about a previous subtitle type, and information about a resumption playback time point.

The second client device CD2 that has received the bookmark may automatically select pieces of playback information for the playback of the content, for example, information about a subtitle language, information about a subtitle type, information about an audio language, and audio type information based on the received bookmark, that is, the resumption playback information, and may set the selected pieces of playback information (step: S35).

For example, the second client device CD2 may automatically select information about a user language, information about a subtitle language, information about a subtitle type, information about a previous audio language, and previous audio type information for playing back the content in the second client device CD2 based on the previous user language information, the previous subtitle language information, the previous subtitle type information, the previous audio language information, and the previous audio type information that are included in the bookmark, and may set the selected information.

The second client device CD2 may play back the downloaded content from the resumption playback time point based on the set information (step: S36). For example, the second client device CD2 may play back the downloaded content from the resumption playback time point, but may temporally synchronize a subtitle or an audio track, corresponding to the automatically selected information, with the downloaded content and then play back the downloaded content.

If the user UR wants to set the subtitle or the audio track again, the second client device CD2 may display a user interface in which the resumption playback information may be set again, and the user UR may select desired subtitle information and desired audio track information.

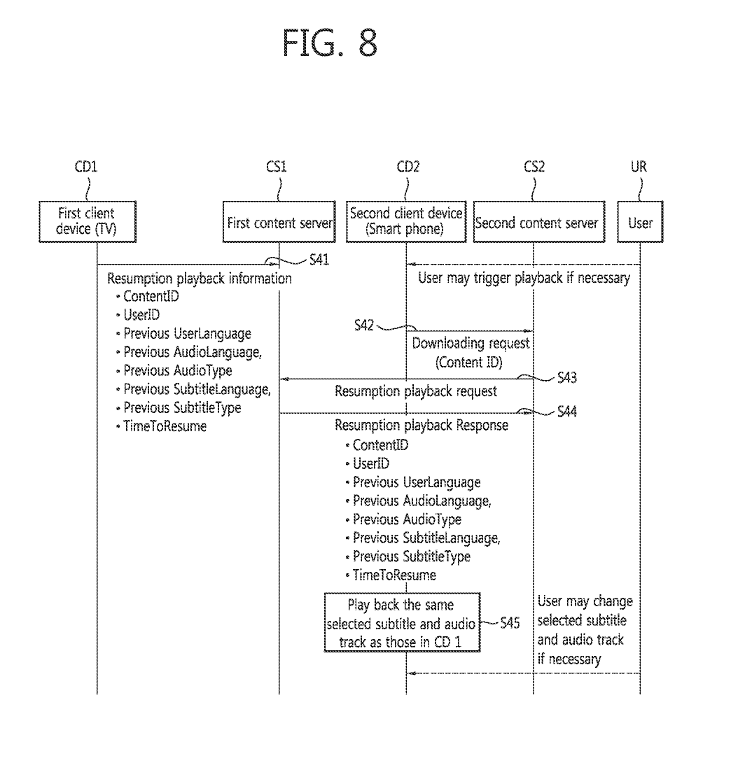

FIG. 8 is a flowchart illustrating a seamless playback method using a bookmark in accordance with yet another preferred embodiment and illustrates an example in which seamless playback is performed based on communication between content servers.

As illustrated in FIG. 8, a user UR watches content using a first client device CD1. The first client device CD1 plays back the content received from a first content server CS1. The first content server CS1 may be a server which provides the content using a streaming method or a downloading method, for example.

The playback information of the content has been set in the first client device CD1 in response to the selection of the user UR. The playback information may include, for example, information for setting a subtitle, an audio track, or the like that is played back along with the content. Accordingly, when the content is played back, additional content may be played back along with the content based on the set playback information.

When the playback of the content by the first client device CD1 is stopped and seamless playback is requested in response to a request from the user UR, the first client device CD1 may generate a bookmark for seamless content resumption playback in another device and send the bookmark to the first content server CS1 (step: S41). The bookmark may include, for example, a content ID, a user ID, information about a previous user language, information about a previous audio language, information about a previous audio type, information about a previous subtitle language, information about a previous subtitle type, and information about a resumption playback time point. The first content server CS1 stores and manages the bookmark received from the first client device CD1.

Meanwhile, the user UR wants to continue to watch the stopped content, watched and stopped in the first client device CD1, using a second client device CD2. In such a case, the user UR may request the seamless playback of the content using a user interface of the second client device CD2. In response to the request, the second client device CD2 may request the content from a second content server CS2, that is, a content server that operates in conjunction with the second client device CD2 (step: S42). The second content server CS2 may be a streaming server. The request includes the content ID and may include information indicative that the content corresponding to the content ID will be seamlessly played back.

Next, the second content server CS2 may request the bookmark, that is, resumption playback information, from the first content server CS1 (step: S43). The first content server CS1 may send a response, including the requested bookmark, to the second content server CS2 in response to the request from the second content server CS2 (step: S44). The bookmark may include, for example, a content ID, a user ID, information about a previous user language, information about a previous audio language, information about a previous audio type, information about a previous subtitle language, information about a previous subtitle type, and information about a resumption playback time point.

The second content server that has received the bookmark may send the content to the second client device CD2 based on the bookmark. In this case, the second content server CS2 may send content from the resumption playback time point, included in the bookmark, to the second client device CD2, may automatically select a subtitle and an audio track corresponding to the resumption playback information and may send the selected subtitle and audio track to the second client device CD2. In response thereto, the second client device CD2 may play back the content from the resumption playback time point along with the subtitle and audio track selected by the second content server CS2 (step: S45).

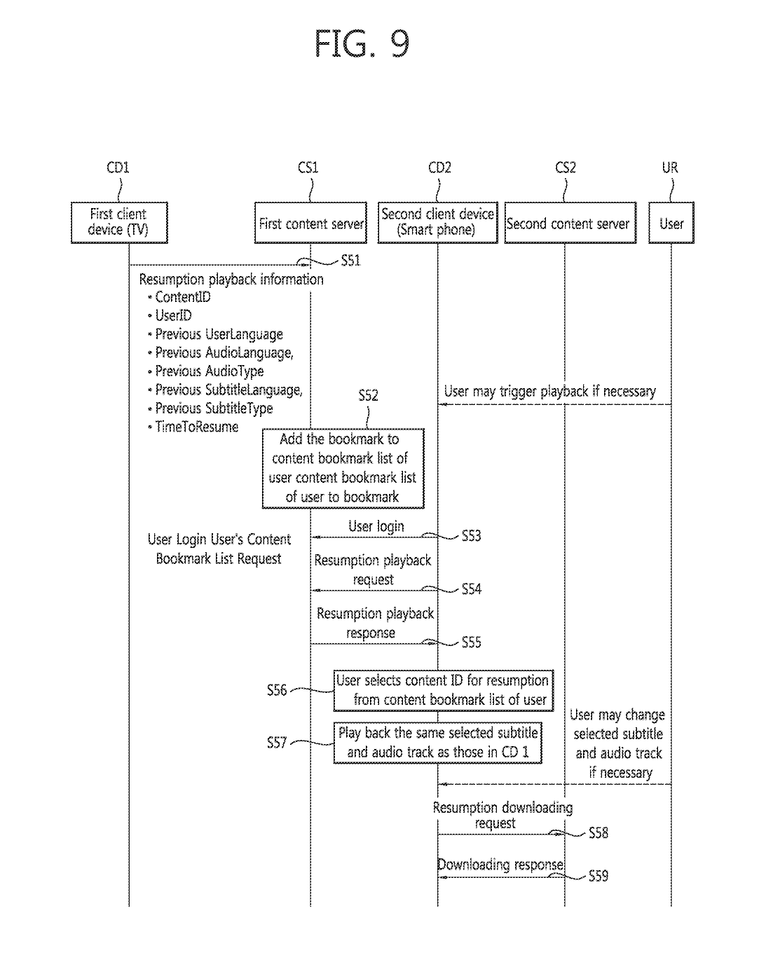

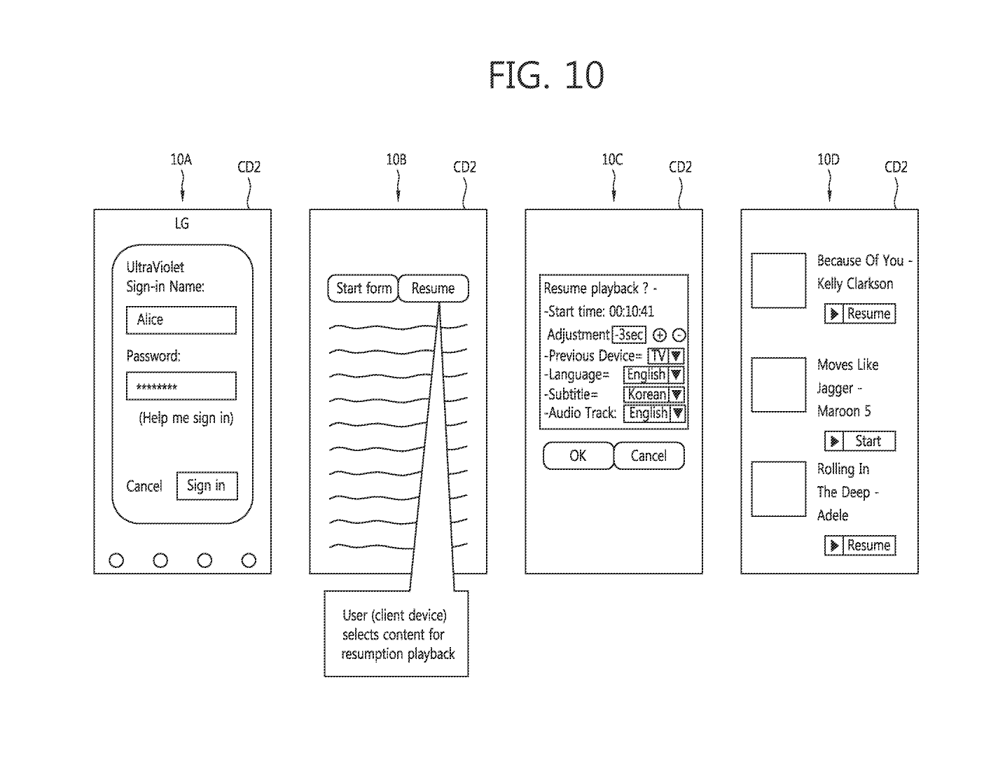

FIG. 9 is a flowchart illustrating a seamless playback method using a bookmark in accordance with yet another preferred embodiment and illustrates an example in which a content server manages the content bookmark list of a user UR. Furthermore, FIG. 10 is an exemplary diagram illustrating the user interfaces of a second client device CD2 according to the seamless playback method using a bookmark illustrated in FIG. 9.

As illustrated in FIG. 9, the user UR watches content using a first client device CD1. For example, the first client device CD1 may play back the content received from a first content server CS1 in a downloading way or streaming way.

The playback information of the content has been set in the first client device CD1 in response to the selection of the user UR. The playback information may include, for example, information for setting a subtitle or an audio track that is played back along with the content. Accordingly, when the content is played back, additional content may be played back along with the content based on the set playback information.

When the playback of the content by the first client device CD1 is stopped and seamless playback is requested in response to a request from the user UR, the first client device CD1 may generate a bookmark for seamless content resumption playback in another device and send the bookmark to the first content server CS1 (step: S51). The bookmark may include, for example, a content ID, a user ID, information about a previous user language, information about a previous audio language, information about a previous audio type, information about a previous subtitle language, information about a previous subtitle type, and information about a resumption playback time point.

The first content server CS1 adds the bookmark, received from the first client device CD1, to the content bookmark list of the user UR (step: S52). The content bookmark list of the user UR may include at least one bookmark corresponding to at least one piece of content that corresponds to the user ID.

Meanwhile, the user UR wants to watch the content using a second client device CD2. To this end, the user UR may log in to the first content server CS1 using the second client device CD2 (step: S53). Such a login process may be performed in such a manner that as in 10A of FIG. 10, the user UR inputs authentication information, for example, a user ID and a password to the second client device CD2, the second client device CD2 sends the received authentication information to the first content server CS1, and the first content server CS1 authenticates the user UR using the authentication information and responds to the second client device CD2.

The authenticated second client device CD2 may send a request that requests the content bookmark list to the first content server CS1 (step: S54). The request process may be performed in such a manner that as in 10B of FIG. 10, the user UR selects a request icon displayed on the second client device CD2, for example, an icon “Resume” and the second client device sends a resumption playback request, including the user ID, to the first content server CS1 in response to the selection.

In response to the request, the first content server CS1 may send a resumption playback response, including the content bookmark list of the user UR, to the second client device CD2 (step: S55). The content bookmark list of the user UR may include at least one bookmark corresponding to at least one piece of content.

The second client device CD2 that has received the content bookmark list of the user UR may display the content list based on the received content bookmark list as illustrated in 10D of FIG. 10. The content list may display a plurality of pieces of content. With respect to pieces of content capable of resumption playback based on the bookmark of the user UR, icons capable of selecting resumption playback may be displayed. For example, in the case of a music video “Because of You” by “Kelly Clarkson” or a music video “Rolling In The Deep” by “Adele”, the icon “Resume” may be displayed because the music video has a history that it was previously played back in the first client device CD1 and stopped. In contrast, in the case of “Move Like Jagger” by “Maroon 5”, an icon “Start” may be displayed because “Move Like Jagger” has no history that it was played back in another device and stopped. The icon “Resume” may be highlighted so that it is easily identified.

The user UR may select content to be watched from the content list (step: S56). For example, the user UR may select the icon “Resume” for the desired content in a user interface, such as that illustrated in 10D. In response thereto, the second client device CD2 may download the content from the second content server CS2 and also extract a bookmark, corresponding to the desired content, from the content bookmark list of the user UR.

The second client device CD2 may display a user interface for setting the playback information of the content, for example, a screen, such as 10C of FIG. 10, based on the extracted bookmark. Information corresponding to the extracted bookmark has been selected from the user interface for setting the playback information. For example, the second client device CD2 may automatically select information about a resumption playback time point, a previous device ID, information about a previous user language, information about a subtitle language, audio track language information, etc. that are included in the bookmark and may display them on a screen on which the playback information of the content may be set.

When the user UR accepts the automatically selected information, the second client device CD2 may set the selected information as the playback information of the content and may play back content, downloaded from a second content server CS2, from the resumption playback time point along with the subtitle and audio track corresponding to the selected information (step: S57). If the user UR wants to set the subtitle or the audio track again, the second client device CD2 may display a user interface, such as that illustrated in FIG. 10C, and the user UR may select desired subtitle information and desired audio track information.

Meanwhile, if the user UR wants to watch another piece of content through the resumption playback of the content in the second client device CD2, the user UR may select another piece of content capable of resumption playback from the content list. In such a case, the second client device CD2 may download the selected another piece of content from the second content server CS2 (step: S58, S59), may extract the bookmark of the selected another piece of content from the content bookmark list of the user UR, and may play back a subtitle or an audio track corresponding to the selected information along with the content resumption playback based on the extracted bookmark.

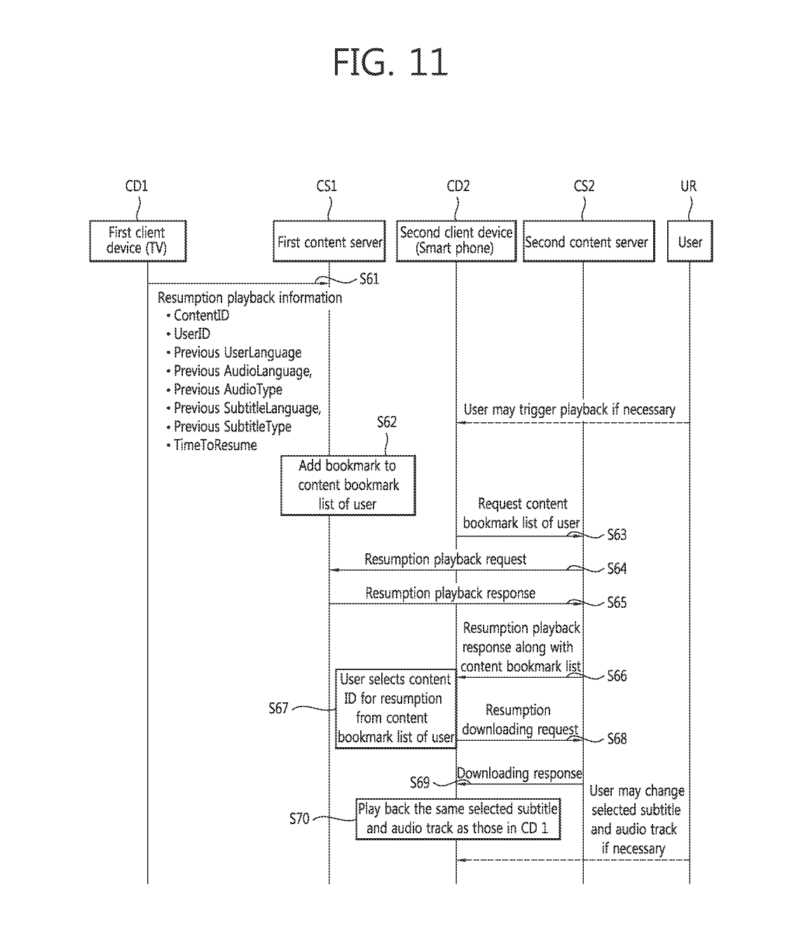

FIG. 11 is a flowchart illustrating a seamless playback method using a bookmark in accordance with yet another preferred embodiment and illustrates an example in which a first content server CS1 manages the content bookmark list of a user UR and a second content server CS2 takes part in the delivery of a bookmark.

As illustrated in FIG. 11, the user UR watches content using a first client device CD1. For example, the first client device CD1 may play back the content that is transmitted by the first content server CS1 in a downloading way or streaming way.

The playback information of the content has been set in the first client device CD1 based on the selection of the user UR. The playback information may include, for example, information for setting a subtitle or an audio track that is played back along with the content. Accordingly, when the content is played back, additional content may be played back along with the content based on the set playback information.

When the playback of the content by the first client device CD1 is stopped and seamless playback is requested in response to a request from the user UR, the first client device CD1 may generate a bookmark for seamless content resumption playback in another device and send the bookmark to the first content server CS1 (step: S61). The bookmark may include, for example, a content ID, a user ID, information about a previous user language, information about a previous audio language, information about a previous audio type, information about a previous subtitle language, information about a previous subtitle type, and information about a resumption playback time point.

The first content server CS1 adds the bookmark, received from the first client device CD1, to the content bookmark list of the user UR (step: S62). The content bookmark list of the user UR may include at least one bookmark corresponding to at least one piece of content corresponding to the user ID.

Meanwhile, the user UR wants to continue to watch the stopped content using a second client device CD2. In such a case, the user UR may request resumption playback through a user interface, such as 10D of FIG. 10. In response to such a request from the user UR, the second client device CD2 may request the content bookmark list of the user UR from the second content server CS2 that operates in conjunction with the second client device CD2 (step: S63).

The second content server CS2 that has received the request may send a resumption playback information request to the first content server CS1 (step: S64). The resumption playback information request may include information that requests the content bookmark list of the user UR. In response to the resumption playback information request, the first content server CS1 may send a resumption playback information response, including the content bookmark list of the user UR, to the second content server CS2 (step: S65). The second content server CS2 may send the content bookmark list of the user UR, received from the first content server CS1, to the second client device CD2 (step: S66).

The second client device CD2 that has received the content bookmark list of the user UR may display the received content bookmark list through a user interface. For example, the second client device CD2 may display the content list based on the content bookmark list, as illustrated in 10D of FIG. 10.

When the user UR selects a desired content ID from the content bookmark list (step: S67), the second client device CD2 may download the selected content from the second content server CS2 (step: S68, S69), may extract a bookmark corresponding to the selected content from the content bookmark list of the user UR, and may automatically select information about a subtitle and an audio track to be used for the playback of the content.

The second client device CD2 may play back the content, downloaded from the second content server CS2, along with the subtitle and audio track corresponding to the information automatically selected from the resumption playback time point based on the automatically selected information (step: S70).

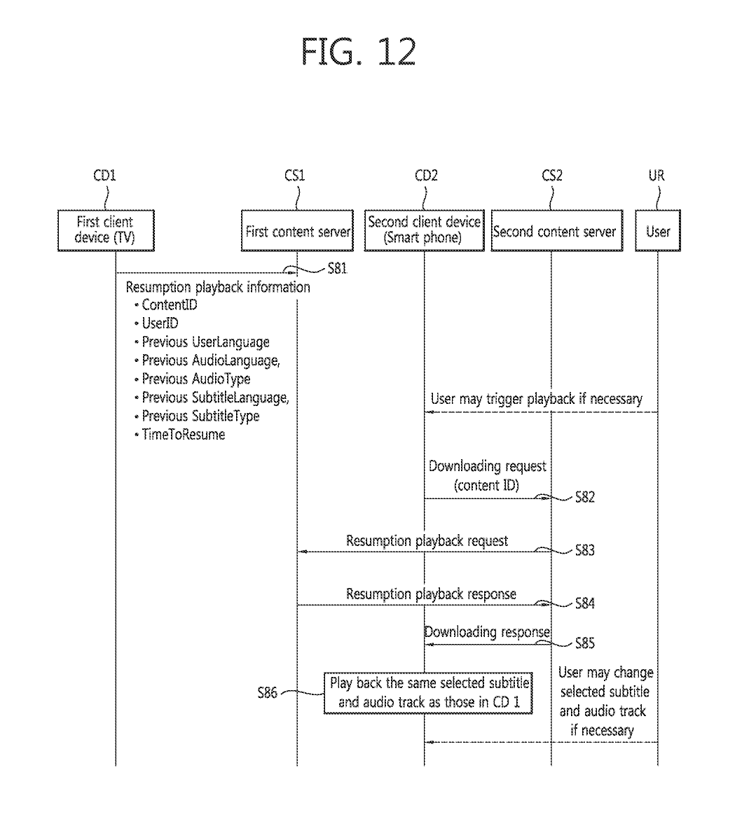

FIG. 12 is a flowchart illustrating a seamless playback method using a bookmark in accordance with yet another preferred embodiment and illustrates an example in which seamless playback is performed based on communication between content servers.

As illustrated in FIG. 12, a user UR watches content using a first client device CD1. The first client device CD1 plays back the content received from a first content server CS1. The first content server CS1 may be a server which provides the content in a streaming way or downloading way, for example.

The playback information of the content has been set in the first client device CD1 based on the selection of the user UR. The playback information may include, for example, information for setting a subtitle or an audio track that is played back along with the content. Accordingly, when the content is played back, additional content may be played back along with the content based on the set playback information.

When the playback of the content by the first client device CD1 is stopped and seamless playback is requested in response to a request from the user UR, the first client device CD1 may generate a bookmark for seamless content resumption playback in another device and send the bookmark to the first content server CS1 (step: S81). The bookmark may include, for example, a content ID, a user ID, information about a previous user language, information about a previous audio language, information about a previous audio type, information about a previous subtitle language, information about a previous subtitle type, and information about a resumption playback time point. The first content server CS1 stores and manages the bookmark received from the first client device CD1.

Meanwhile, the user UR wants to continue to watch the content, watched and stopped in the first client device CD1, using a second client device CD2. In such a case, the user UR may request the seamless playback of the content using a user interface of the second client device CD2. In response thereto, the second client device CD2 may request the content from a second content server CS2, that is, a content server that operates in conjunction with the second client device CD2 (step: S82). The second content server CS2 may be a download provider. The request includes the content ID and may include information indicative that the content corresponding to the content ID will be seamlessly played back.

Next, the second content server CS2 may request the bookmark, that is, resumption playback information, from the first content server CS1 (step: S83). The first content server CS1 may send a response, including the requested bookmark, to the second content server CS2 in response to the request from the second content server CS2 (step: S84). The bookmark may include, for example, the content ID, the user ID, the previous user language information, the previous audio language information, the previous audio type information, the previous subtitle language information, the previous subtitle type information, and the resumption playback time point information.

The second content server CS2 that has received the bookmark may download the content onto the second client device CD2 based on the bookmark (step: S85). Furthermore, the second content server CS2 may send the bookmark to the second client device CD2. The second client device CD2 may automatically select pieces of information, related to a subtitle and an audio track, identically with the playback information in the first client device CD1 based on the bookmark received from the second content server CS2.

Next, the second client device CD2 may play back the downloaded content along with the subtitle and audio track, corresponding to the automatically selected information, from a point of time at which the playback of the content was stopped in the first client device CD1 (step: S86).

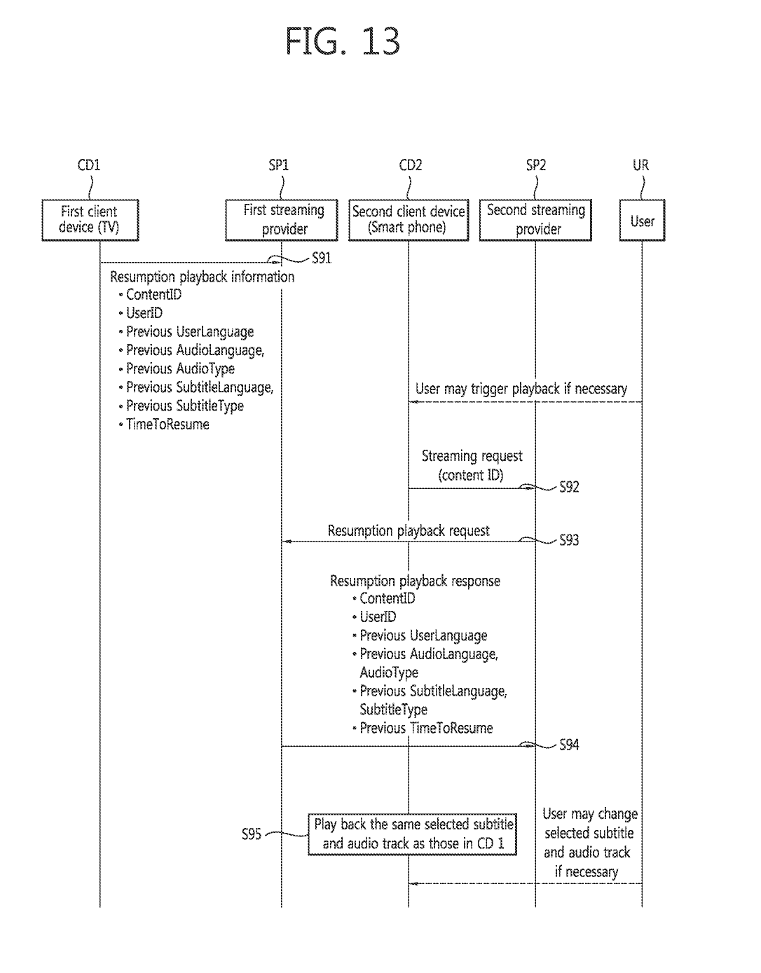

FIG. 13 is a flowchart illustrating a seamless playback method using a bookmark in accordance with yet another preferred embodiment and illustrates an example in which seamless playback is performed based on communication between streaming providers.

As illustrated in FIG. 13, a user UR watches content using a first client device CD1. The first client device CD1 plays back the content received from a first streaming provider SP1.

The playback information of the content has been set in the first client device CD1 based on the selection of the user UR. The playback information may include, for example, information for setting a subtitle or an audio track that is played back along with the content. Accordingly, when the content is played back, additional content may be played back along with the content based on the set playback information.

When the playback of the content by the first client device CD1 is stopped and seamless playback is requested in response to a request from the user UR, the first client device CD1 may generate a bookmark for seamless content resumption playback in another device and send the bookmark to the first streaming provider SP1 (step: S91). The bookmark may include, for example, a content ID, a user ID, information about a previous user language, information about a previous audio language, information about a previous audio type, information about a previous subtitle language, information about a previous subtitle type, and information about a resumption playback time point. The first streaming provider SP1 stores and manages the bookmark received from the first client device CD1.

Meanwhile, the user UR wants to continue to watch the content that was played back and stopped in the first client device CD1 using a second client device CD2. In such a case, the user UR may request the seamless playback of the content using a user interface of the second client device CD2. In response to the request, the second client device CD2 may request the content from a second streaming provider SP2, that is, a content server that operates in conjunction with the second client device CD2 (step: S92). The request includes the content ID and may include information indicative that the content corresponding to the content ID will be seamlessly played back.

Next, the second streaming provider SP2 may request bookmark, that is, resumption playback information, from the first streaming provider SP1 (step: S93). The first streaming provider SP1 may send a response, including the requested bookmark, to the second streaming provider SP2 in response to the request from the second streaming provider SP2 (step: S94). The bookmark may include, for example, the content ID, the user ID, the previous user language information, the previous audio language information, the previous audio type information, the previous subtitle language information, the previous subtitle type information, and the resumption playback time point information.

The second streaming provider SP2 that has received the bookmark may stream the content to the second client device CD2 based on the received bookmark. In this case, the second streaming provider SP2 may send content from the resumption playback time point, included in the bookmark, to the second client device CD2. Furthermore, the second streaming provider SP2 may automatically select a subtitle and an audio track, corresponding to the resumption playback information, to the second client device CD2. In response thereto, the second client device CD2 may play back the content from the resumption playback time point along with the subtitle and the audio track selected by the second streaming provider SP2 (step: S95).

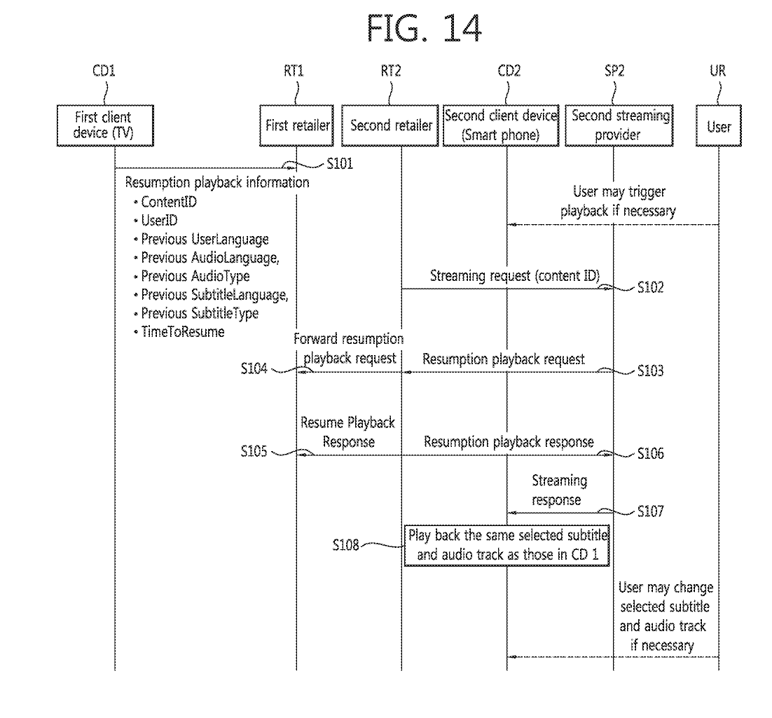

FIG. 14 is a flowchart illustrating a seamless playback method using a bookmark in accordance with yet another preferred embodiment and illustrates an example in which seamless playback is performed based on communication between retailers.

As illustrated in FIG. 14, a user UR watches content using a first client device CD1. It is assumed that the first client device CD1 plays back content received from a first streaming provider SP1 although not illustrated. The playback information of the content has been set in the first client device CD1 based on the selection of the user UR. The playback information may include, for example, information for setting a subtitle or an audio track that is played back along with the content. Accordingly, when the content is played back, additional content may be played back along with the content based on the set playback information.

When the playback of the content by the first client device CD1 is stopped and seamless playback is requested in response to a request from the user UR, the first client device CD1 may generate a bookmark for seamless content resumption playback in another device and send the bookmark to a first retailer RT1 (step: S101). The bookmark may include, for example, a content ID, a user ID, information about a previous user language, information about a previous audio language, information about a previous audio type, information about a previous subtitle language, information about a previous subtitle type, and information about a resumption playback time point. The first retailer RT1 stores and manages the bookmark received from the first client device CD1.

Meanwhile, the user UR wants to continue to watch the content, watched and stopped in the first client device CD1, using a second client device CD2. In such a case, the user UR may request the seamless playback of the content using a user interface of the second client device CD2. In response to the request, the second client device CD2 may deliver the request to a second retailer RT2 that operates in conjunction with the second client device CD2, and the second retailer RT2 may send a streaming request that requests the streaming of the content to a second streaming provider SP2 (step: S102). The streaming request includes the content ID, and may include information indicative that the content corresponding to the content ID will be seamlessly played back.

Next, the second streaming provider SP2 may send a resumption playback request that requests the bookmark, corresponding to the content, to the second retailer RT2 (step: S103). The second retailer RT2 may forward the resumption playback request to the first retailer RT1 (step: S104). The first retailer RT1 may send a response, including the requested bookmark, to the second retailer RT2 in response to the resumption playback request from the second retailer RT2 (step: S105). The second retailer RT2 may send the received response to the second streaming provider SP2 (step: S106). The bookmark may include, for example, the content ID, the user ID, the previous user language information, the previous audio language information, the previous audio type information, the previous subtitle language information, the previous subtitle type information, and the resumption playback time point information.

The second streaming provider SP2 that has received the bookmark may stream the content to the second client device CD2 (step: S107). In this case, the second streaming provider SP2 may send content from the resumption playback time point, included in the received bookmark, to the second client device CD2 based on the received bookmark.

The second streaming provider SP2 may automatically select a subtitle and an audio track based on the bookmark and may send the subtitle and the audio track to the second client device CD2. Accordingly, the second client device CD2 may play back the content, streamed from the second streaming provider SP2, along with the subtitle and the audio track selected by the second streaming provider SP2 (step: S108). Alternatively, the second streaming provider SP2 may deliver the received bookmark to the second client device CD2. In such a case, the second client device CD2 may automatically select information, such as the subtitle and the audio track, based on the bookmark received from the second streaming provider SP2 and may play back the subtitle and audio track, corresponding to the selected information, along with the content.

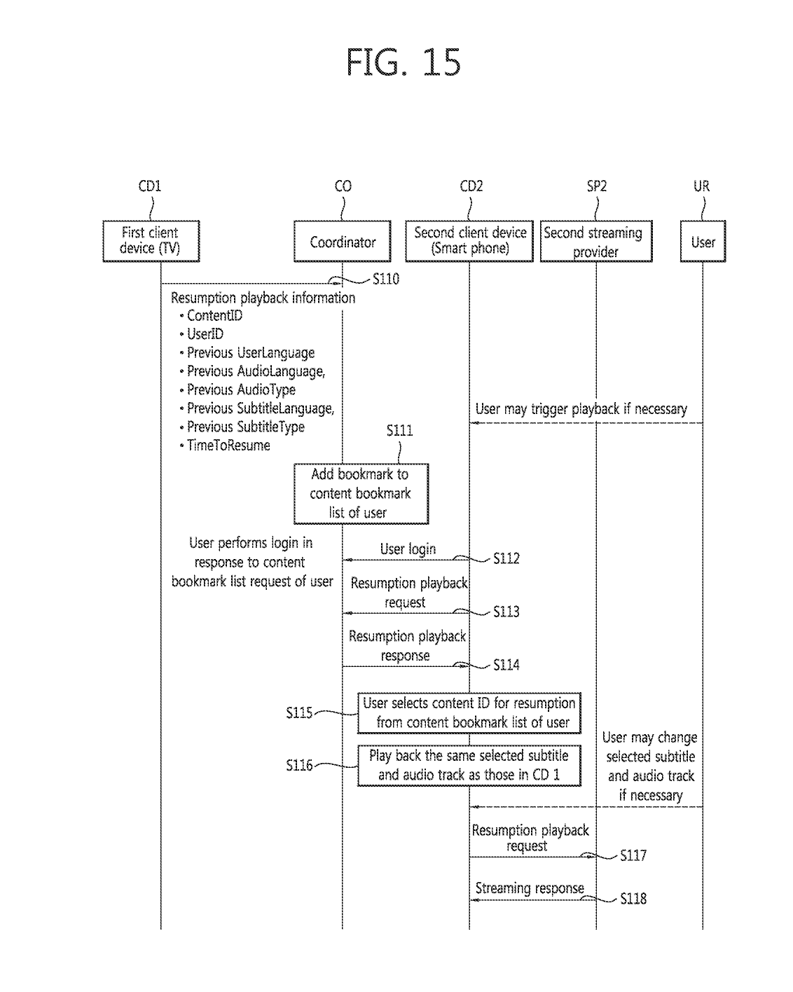

FIG. 15 is a flowchart illustrating a seamless playback method using a bookmark in accordance with yet another preferred embodiment and illustrates an example in which a coordinator CO that manages the open content market service manages the content bookmark list of a user.

As illustrated in FIG. 15, a user UR watches content using a first client device CD1. For example, the first client device CD1 may play back the content transmitted by a specific content server in a downloading way or streaming way.

The playback information of the content has been set in the first client device CD1 based on the selection of the user UR. The playback information may include, for example, information for setting a subtitle or an audio track that is played back along with the content. Accordingly, when the content is played back, additional content may be played back along with the content based on the set playback information.

When the playback of the content by the first client device CD1 is stopped and seamless playback is requested in response to a request from the user UR, the first client device CD1 may generate a bookmark for seamless content resumption playback in another device and send the bookmark to the coordinator CO (step: S110). The bookmark may include, for example, a content ID, a user ID, information about a previous user language, information about a previous audio language, information about a previous audio type, information about a previous subtitle language, information about a previous subtitle type, and information about a resumption playback time point.

The coordinator CO adds the bookmark, received from the first client device CD1, to the content bookmark list of the user UR (step: S111). The content bookmark list of the user UR may include at least one bookmark corresponding to at least one piece of content corresponding to the user ID.

Meanwhile, the user UR wants to watch the content using a second client device CD2. To this end, the user UR may log in to the coordinator CO using the second client device CD2 (step: S112). The authenticated second client device CD2 may send a request that requests the content bookmark list of the user UR to the coordinator CO (step: S113). In response to the request, the coordinator CO may send a resumption playback response, including the content bookmark list of the user UR, to the second client device CD2 (step: S116). The bookmark list of the user UR may include at least one bookmark corresponding to at least one piece of content.

The second client device CD2 that has received the bookmark list of the user UR may display the received content bookmark list using a user interface. For example, the second client device CD2 may display the content list based on the content bookmark list, as illustrated in 10D of FIG. 10.

When the user UR selects a desired content ID from the displayed content bookmark list (step: S115), the second client device CD2 may extract a bookmark corresponding to the selected content ID. The second client device CD2 may select the playback information of content to be played back based on the extracted bookmark, for example, a subtitle language, a subtitle type, an audio track language, and an audio track type and may play back a subtitle or an audio track, corresponding to the playback information, along with the content received from a selected second streaming provider SP2 in a streaming way (step: S116˜S118).

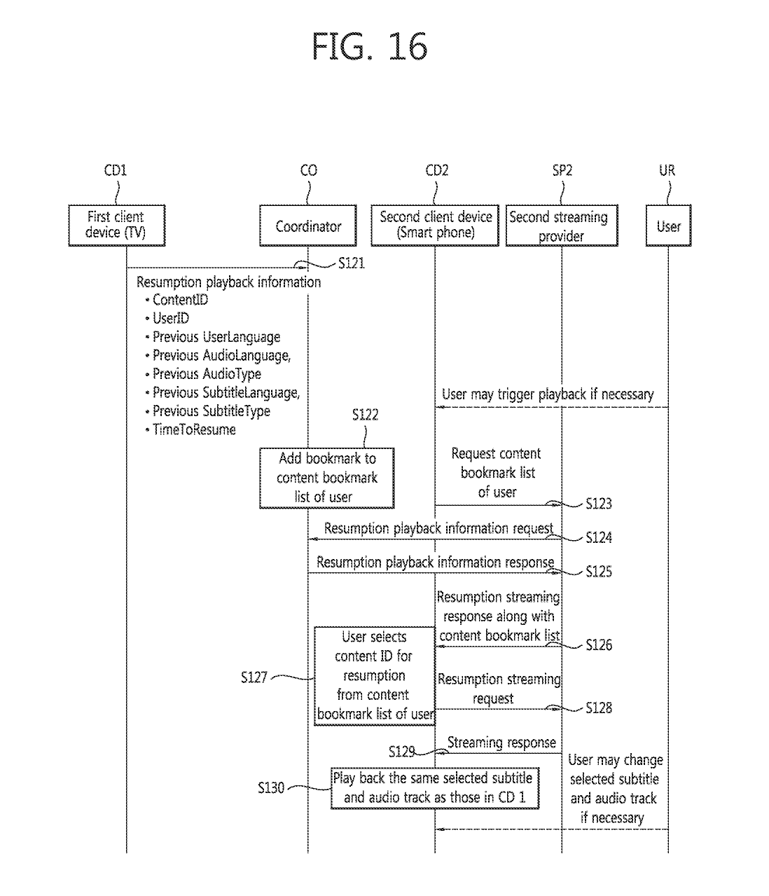

FIG. 16 is a flowchart illustrating a seamless playback method using a bookmark in accordance with yet another preferred embodiment and illustrates an example in which a coordinator CO manages the content bookmark list of a user UR and a second streaming provider SP2 takes part in the delivery of a bookmark.

As illustrated in FIG. 16, the user UR watches content using a first client device CD1. For example, the first client device CD1 may play back the content received from a specific content server in a downloading way or streaming way.

The playback information of the content has been set in the first client device CD1 based on the selection of the user UR. The playback information may include, for example, information for setting a subtitle or an audio track that is played back along with the content. Accordingly, when the content is played back, additional content may be played back along with the content based on the set playback information.

When the playback of the content by the first client device CD1 is stopped and seamless playback is requested in response to a request from the user UR, the first client device CD1 may generate a bookmark for seamless content resumption playback in another device and send the bookmark to the coordinator CO (step: S121). The bookmark may include, for example, a content ID, a user ID, information about a previous user language, information about a previous audio language, information about a previous audio type, information about a previous subtitle language, information about a previous subtitle type, and information about a resumption playback time point.

The coordinator CO adds the bookmark, received from the first client device CD1, to the content bookmark list of the user UR (step: S122). The content bookmark list of the user UR may include at least one bookmark corresponding to at least one piece of content corresponding to the user ID.

Meanwhile, the user UR wants to continue to watch the stopped content using a second client device CD2. In such a case, the user UR may request resumption playback through a user interface, such as that of 10B of FIG. 10. In response to the request from the user UR, the second client device CD2 may request the content bookmark list of the user UR from the second streaming provider SP2 that operates in conjunction with the second client device CD2 (step: S123).

The second streaming provider SP2 that has received the request may send a resumption playback information request to the coordinator CO (step: S124). The resumption playback information request may include information that requests the content bookmark list of the user UR. In response to the resumption playback information request, the coordinator CO may send a resumption playback information response, including the content bookmark list of the user UR, to the second streaming provider SP2 (step: S125). The second streaming provider SP2 may send the content bookmark list of the user UR, received from the coordinator CO, to the second client device CD2 (step: S126).

The second client device CD2 that has received the content bookmark list of the user UR may display the received content bookmark list through a user interface. For example, the second client device CD2 may display a content list based on the content bookmark list as illustrated in 10D of FIG. 10.

When the user UR selects a desired content ID from the content bookmark list (step: S127), the second client device CD2 may download the selected content from the second streaming provider SP2 (step: S128, S129), may extract a bookmark corresponding to the selected content from the content bookmark list of the user UR, and may automatically select information about a subtitle and an audio track that will be used when the content is played back.

The second client device CD2 may play back the content, downloaded from the second streaming provider SP2, along with the subtitle and the audio track corresponding to the automatically selected information from the resumption playback time point based on the automatically selected information (step: S130).

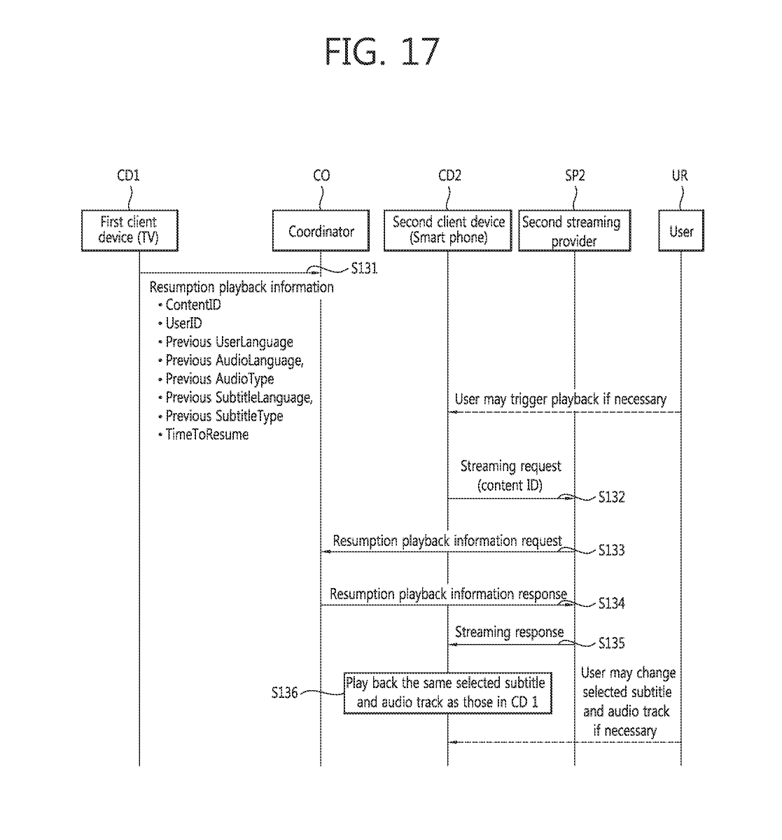

FIG. 17 is a flowchart illustrating a seamless playback method using a bookmark in accordance with yet another preferred embodiment and illustrates an example in which seamless playback is performed based on communication between a coordinator CO and a second streaming provider SP2.

As illustrated in FIG. 17, a user UR watches content using a first client device CD1. It is assumed that the first client device CD1 receives the content from a specific content server in a streaming way or downloading way and plays back the received content.

The playback information of the content has been set in the first client device CD1 based on the selection of the user UR. The playback information may include, for example, information for setting a subtitle or an audio track that is played back along with the content. Accordingly, when the content is played back, additional content may be played back along with the content based on the set playback information.

When the playback of the content by the first client device CD1 is stopped and seamless playback is requested in response to a request from the user UR, the first client device CD1 may generate a bookmark for seamless content resumption playback in another device and send the bookmark to the coordinator CO (step: S131). The bookmark may include, for example, a content ID, a user ID, information about a previous user language, information about a previous audio language, information about a previous audio type, information about a previous subtitle language, information about a previous subtitle type, and information about a resumption playback time point. The coordinator CO stores and manages the bookmark received from the first client device CD1.

Meanwhile, the user UR wants to continue to watch the content, watched and stopped in the first client device CD1, using a second client device CD2. In such a case, the user UR may request the seamless playback of the content using a user interface of the second client device CD2. In response to the request, the second client device CD2 may request the content from the second streaming provider, that is, a content server that operates in conjunction with the second client device CD2 (step: S132). The request includes the content ID and may include information indicative that the content corresponding to the content ID will be seamlessly played back.

Next, the second streaming provider SP2 may request the bookmark, that is, resumption playback information, from the coordinator CO (step: S133). The coordinator CO may send a response, including the requested bookmark, to the second streaming provider SP2 in response to the request from the second streaming provider SP2 (step: S134). The bookmark may include, for example, the content ID, the user ID, the previous user language information, the previous audio language information, the previous audio type information, the previous subtitle language information, the previous subtitle type information, and the resumption playback time point information.

The second streaming provider SP2 that has received the bookmark may stream the content to the second client device CD2 based on the bookmark (step: S135). Furthermore, the second streaming provider SP2 may send the bookmark to the second client device CD2. The second client device CD2 may automatically select pieces of information related to the subtitle and the audio track identically with the playback information in the first client device CD1 based on the bookmark received from the second streaming provider SP2, and may play back the streamed content along with the subtitle and audio track, corresponding to the automatically selected information, from a point of time at which the playback of the content was stopped in the first client device CD1 (step: S136)

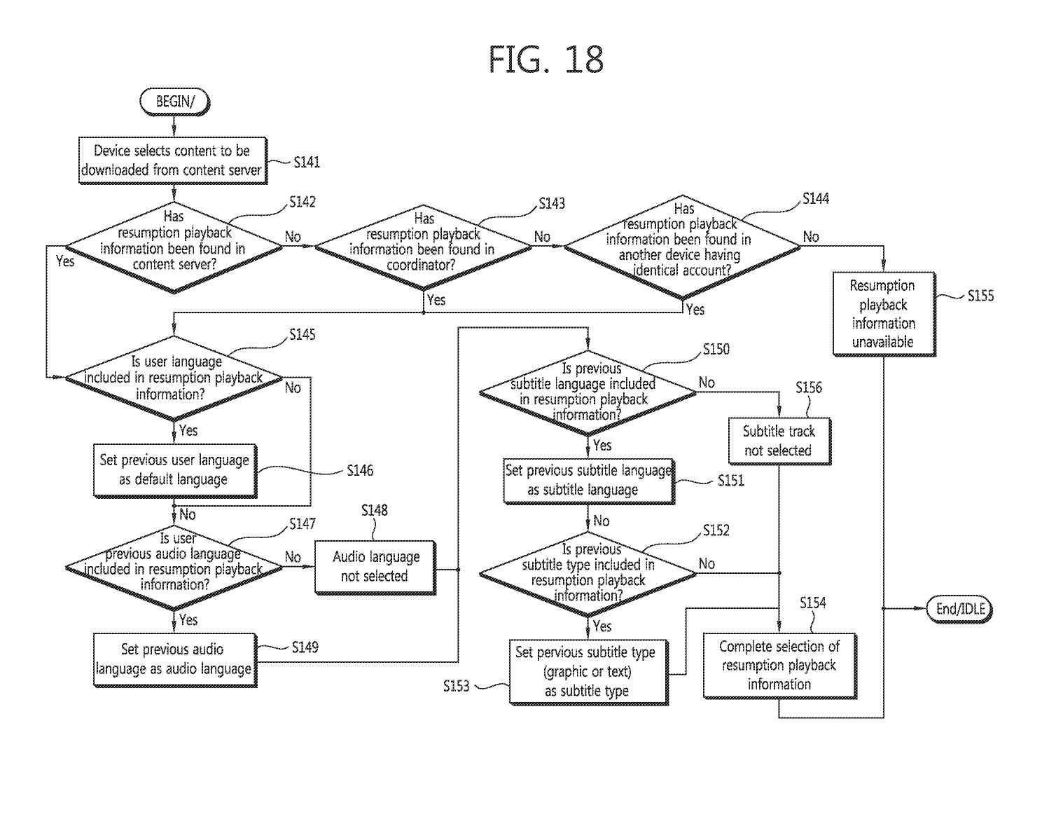

FIG. 18 is a flowchart illustrating a seamless playback method using a bookmark in accordance with yet another preferred embodiment and illustrates an embodiment of a flowchart of a device for performing resumption playback based on a bookmark.

As illustrated in FIG. 18, first, the device may select content to be downloaded from a content server (step: S141) and may determine whether or not a bookmark corresponding to the selected content, that is, resumption playback information, is found in the content server, a coordinator, or another device having the same user account (steps: S142, S143, S144).

If the resumption playback information is determined to be not found in any of the content server, the coordinator, and another device having the same user account, the device determines that available resumption playback information is not present and terminates the procedure (step: S155).

If the resumption playback information is determined to be found in any of the content server, the coordinator, and another device having the same user account, the device determines whether or not the resumption playback information includes a previous user language (step: S145). If the resumption playback information is determined to include the previous user language, the device sets the previous user language as a default language (step: S146).

Next, the device determines whether or not the resumption playback information includes a previous audio language (step: S147). If the resumption playback information is determined to include the previous audio language, the device sets the previous audio language as the language of an audio track (step: S149). If the resumption playback information is determined to not include a previous audio language, an audio language is not selected (step: S148).

Thereafter, the device determines whether or not a previous subtitle language is included in the resumption playback information (step: S150). If the resumption playback information is determined to include the previous subtitle language, the device sets the previous subtitle language as the language of a subtitle (step: S151). If the resumption playback information is determined to not include the previous subtitle language, a subtitle language is not selected (step: S156).

Next, the device determines whether or not a previous subtitle type is included in the resumption playback information (step: S152). If the resumption playback information is determined to include the previous subtitle type, the device sets the previous subtitle type as the type of subtitle (step: S153). If the resumption playback information is determined to not include the previous subtitle type, a subtitle type is not selected (step: S154).

Although the embodiments of the present invention have been described above, those skilled in the art will appreciate that the present invention may be modified in various ways without departing from the spirit and scope of the present invention defined in the appended claims. Accordingly, a possible change of the embodiments of the present invention will not depart from the technology of the present invention.

What is claimed is:

1. A seamless playback method using a bookmark which is performed by a device, the method comprising steps of:
receiving a bookmark, comprising playback information of a previous device that previously played back content, from any one of the previous device and a server;
setting playback information for playing back the content in the device based on the playback information of the previous device; and
playing back the content and additional content corresponding to the set playback information from a resumption playback time point based on the set playback information.

2. The seamless playback method of claim 1, wherein the bookmark comprises:
a content ID for identifying the content;
previous subtitle language information indicative of a subtitle language set in the previous device;
previous subtitle type information indicative of a subtitle type set in the previous device;
previous audio track language information indicative of an audio track language set in the previous device;
previous audio track type information indicative of a type of audio track set in the previous device; and
the resumption playback time point indicative of a point of time at which the playback of the content is to be resumed in the device.

3. The seamless playback method of claim 1, wherein the step of setting the playback information comprises at least any one of steps of:
selecting information about a subtitle to be played back in association with the content based on previous subtitle information included in the bookmark; and
selecting information about an audio track to be played back in association with the content based on previous audio track information included in the bookmark.

4. The seamless playback method of claim 1, wherein the step of setting the playback information comprises steps of:
selecting information about additional content to be played back in association with the content identically with information about additional content set in the previous device based on the bookmark;
displaying the selected information about additional content using a user interface; and
setting the selected information about additional content in response to a user request input signal.

5. The seamless playback method of claim 1, further comprising steps of:
discovering the previous device by performing device discovery; and
requesting the bookmark, comprising the playback information of the previous device, from the previous device.

6. The seamless playback method of claim 1, wherein the step of receiving a bookmark, comprising playback information of a previous device that previously played back content, from any one of the previous device and a server comprises a step of receiving a content bookmark list comprising at least one bookmark corresponding to at least one piece of content.

7. The seamless playback method of claim 6, further comprising steps of:
displaying a user interface based on the content bookmark list; and
extracting a bookmark, corresponding to the content, from the bookmark list when the content is selected from the content bookmark list.

8. The seamless playback method of claim 7, wherein the user interface based on the bookmark list displays a list of a plurality of pieces of content comprising the at least one piece of content and displays information indicative that resumption playback of content comprising a corresponding bookmark is possible.

9. A seamless playback apparatus using a bookmark, comprising:
an interface for receiving a bookmark, comprising playback information of a previous device that previously played back content, from any one of the previous device and a server; and
a processor for setting playback information for playing back the content in the device based on the playback information of the previous device and for playing back the content and additional content corresponding to the set playback information from a resumption playback time point based on the set playback information.

10. The seamless playback apparatus of claim 9, wherein the bookmark comprises:
a content ID for identifying the content;
previous subtitle language information indicative of a subtitle language set in the previous device;
previous subtitle type information indicative of a subtitle type set in the previous device;
previous audio track language information indicative of an audio track language set in the previous device;
previous audio track type information indicative of a type of audio track set in the previous device; and
the resumption playback time point indicative of a point of time at which the playback of the content is to be resumed in the device.

11. The seamless playback apparatus of claim 9, wherein the processor performs at least any one of selecting information about a subtitle to be played back in association with the content based on previous subtitle information included in the bookmark and of selecting information about an audio track to be played back in association with the content based on previous audio track information included in the bookmark.

12. The seamless playback apparatus of claim 9, wherein the processor selects information about additional content to be played back in association with the content identically with information about additional content set in the previous device based on the bookmark, displays the selected information about additional content using a user interface, and sets the selected information about additional content in response to a user request input signal.

13. A seamless playback system using a bookmark, comprising:
a first device for generating a bookmark so that content and additional content associated with the content are able to be seamlessly played back in another device when playback of the content is stopped; and
a second device for receiving the bookmark generated by the first device from any one of the first device and a server, setting playback information for playing back the content based on the bookmark, and seamlessly playing back the content and additional content corresponding to the set playback information based on the set playback information.

14. The seamless playback system of claim 13, wherein the bookmark comprises:
a content ID for identifying the content;
previous subtitle language information indicative of a subtitle language set in the previous device;
previous subtitle type information indicative of a subtitle type set in the previous device;
previous audio track language information indicative of an audio track language set in the previous device;
previous audio track type information indicative of a type of audio track set in the previous device; and
the resumption playback time point indicative of a point of time at which the playback of the content is to be resumed in the device.

15. The seamless playback system of claim 13, wherein the second device performs at least any one of selecting information about a subtitle to be played back in association with the content based on previous subtitle information included in the bookmark and of selecting information about an audio track to be played back in association with the content based on previous audio track information included in the bookmark.

16. The seamless playback system of claim 14, wherein the second device selects information about additional content to be played back in association with the content identically with information about additional content set in the previous device based on the bookmark, displays the selected information about additional content using a user interface, and sets the selected information about additional content in response to a user request input signal.

17. The seamless playback system of claim 13, wherein the second device receives a content bookmark list comprising at least one bookmark corresponding to at least one piece of content, displays a user interface based on the content bookmark list, and extracts a bookmark corresponding to the content from the bookmark list when the content is selected from the content bookmark list.
